(19) United States
(12) Patent Application Publication
(10) Pub. No.: US 2009/0066227 A1
(43) Pub. Date: Mar. 12, 2009

(54) ORGANIC LIGHT-EMITTING DEVICE

(75) Inventors: Keiji Okinaka, Kawasaki-shi (JP); Naoki Yamada, Inagi-shi (JP); Satoshi Igawa, Fujisawa-shi (JP); Jun Kamatani, Tokyo (JP); Masataka Yashima, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/913,046

(22) PCT Filed: Aug. 12, 2006
(86) PCT No.: PCT/JP2006/324996

§ 371 Date: Oct. 29, 2007

(30) Foreign Application Priority Data
Dec. 20, 2005 (JP) 2005-366556
Apr. 28, 2006 (JP) 2006-125013
Oct. 12, 2006 (JP) 2006-278925

(51) Int. Cl. C09K 11/06

(52) U.S. Cl. 313/504

(57) ABSTRACT

An object of the present invention is to provide an organic blue-light-emitting device having high emission efficiency and a long continuous driving lifetime. The organic light-emitting device include a layer containing a first compound having a fluoranthene skeleton and a second compound having a pyrene skeleton, the second compound having an energy gap larger than that of the first compound, wherein EL1 representing the energy of the lowest unoccupied molecular orbit (LUMO) of the first compound and EL2 representing the energy of the LUMO of the second compound satisfy a relationship of EL2−EL1≧0.15 eV.

### TECHNICAL FIELD

The present invention relates to a light-emitting device using an organic compound, and more specifically, to an organic light-emitting device that emits light by applying an electric field to a thin film composed of an organic compound.

### BACKGROUND ART

An organic light-emitting device includes a thin film containing a luminescent organic compound which is interposed between an anode and a cathode. In the device, holes and electrons are injected from the respective electrodes to generate excitons of the luminescent organic compound and then light is irradiated when the excitons return to its ground state. The device utilizes the light to be radiated.

Appl. Phys. Lett. 51, 913 (1987) reports a separated-function device constituted of two layers. The device uses ITO in its anode, uses an alloy of magnesium and silver in its cathode, uses an aluminum quinolinol complex as an electron transport material and a light-emitting material, and uses a triphenylamine derivative as a hole transport material. In addition, the document reports that the device emits light having a luminance of about 1,000 cd/m² at an applied voltage of about 10 V.

In addition, an organic phosphorescent-light-emitting device using an iridium complex such as Ir(ppy)₃ as a light-emitting material has been recently attracting attention and reported to have a high emission efficiency (Appl. Phys. Lett. 75, 4 (1999)).

An organic light-emitting device has recently showed significant progress. The device suggests its potential to find use in a wide variety of applications because of its characteristics such as the fact that the device can be produced into a thin light-weight light-emitting device which shows high luminance at a low applied voltage, has a variety of emission wavelengths and provides high-speed response.

However, particularly in a case where it is assumed that a current organic light-emitting device is applied to, for example, a full-color display, the emission efficiency and stability of the device are not sufficient for the device to be put into practical use. In particular, an additional improvement in performance of a blue-light-emitting device has been needed.

Regarding an improvement in stability of a blue-light-emitting device, Japanese Patent Application Laid-Open No. 2005-108726 discloses a device characterized in that a light-emitting layer contains an electron movable material, a hole movable material as an assist dopant, and a luminescent dopant.

For example, Japanese Patent Application Laid-Open No. H10-189248 discloses a device containing a fluoranthene skeleton material.

For example, SOCIETY FOR INFORMATION DISPLAY 2003 INTERNATIONAL SYMPOSIUM, DIGEST OF TECHNICAL PAPERS, 45. 3, 1294 (2003) discloses a device containing a pyrene skeleton material.

### DISCLOSURE OF THE INVENTION

An object of the present invention is to provide a blue-light-emitting device having a high emission efficiency and a long continuous driving lifetime.

The inventors of the present invention have made extensive studies with a view to solving the above-mentioned problems. As a result, they have accomplished the present invention.

That is, the present invention provides an organic light-emitting device, including: a pair of electrodes composed of an anode and a cathode; and a layer composed of an organic compound and interposed between the pair of electrodes,

Wherein the layer has a light-emitting region and contains a first compound having a fluoranthene skeleton and a second compound having a pyrene skeleton, the second compound having an energy gap larger than an energy gap of the first compound; and

a lowest unoccupied molecular orbital energy EL1 of the first compound and a lowest unoccupied molecular orbital energy EL2 of the second compound satisfy a relationship of EL2−EL1≧0.15 eV.

According to the present invention, there can be provided a blue-light-emitting device having a high emission efficiency and a long continuous driving lifetime.

Further features of the present invention will become apparent from the following description of exemplary embodiments with reference to the attached drawings.

### BRIEF DESCRIPTION OF THE DRAWINGS

FIG. 1 is a sectional view showing an example of an organic light-emitting device of the present invention;

FIG. 2 is a sectional view showing another example of the organic light-emitting device of the present invention;

FIG. 3 is a sectional view showing still another example of the organic light-emitting device of the present invention; and

FIG. 4 is a sectional view showing further example of the organic light-emitting device of the present invention.

### BEST MODE FOR CARRYING OUT THE INVENTION

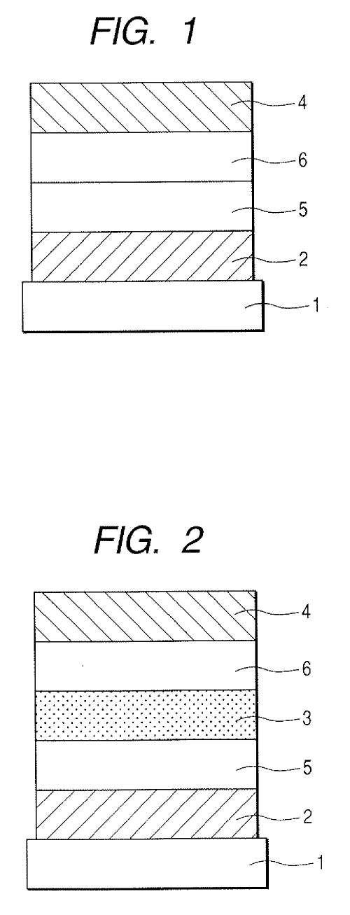

FIGS. 1 to 4 each show examples of the constitution of an organic light-emitting device of the present invention.

FIG. 1 shows a constitution obtained by sequentially providing, on a substrate 1, an anode 2, a hole transport layer 5, an electron transport layer 6, and a cathode 4. In this case, one of the hole transport layer and the electron transport layer serves as a light-emitting layer.

FIG. 2 shows a constitution obtained by sequentially providing, on the substrate 1, the anode 2, the hole transport layer 5, a light-emitting layer 3, the electron transport layer 6, and the cathode 4. In this constitution, a carrier transport function and a light-emitting function are separated from each other, and a region in which a hole and an electron recombine with each other is present in the light-emitting layer. The constitution is suitably used in combination with compounds having respective properties, that is, hole transport property, electron transport property, and light-emitting property, so the degree of freedom in the selection of materials extremely increases. In addition, the variety of emission hues can be increased because various compounds different in emission wavelength from each other can be used. Further, emission efficiency can be improved by effectively confining each carrier or each exciton in the light-emitting layer 3 as a central layer.

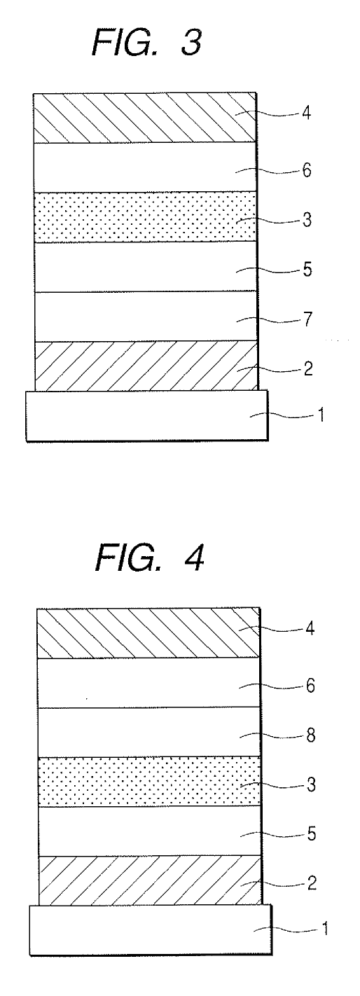

FIG. 3 shows a constitution different from that shown in FIG. 2 in that a hole injection layer 7 as one kind of a hole transport layer is inserted on a side of the anode 2 and has an improving effect on adhesiveness between the anode 2 and the hole transport layer 5 or on hole injection property, and is effective for a reduced voltage at which the device is driven.

FIG. 4 shows a constitution different from that shown in FIG. 2 in that a hole block layer 8 as one kind of an electron transport layer is provided between the light-emitting layer 3 and the electron transport layer 6. This constitution includes a compound having a large ionization potential (that is, a low HOMO energy) in the hole block layer 8 to alleviate the leak of a hole from the light-emitting layer toward a cathode side, and is effective for an improvement in emission efficiency.

In the present invention, the light-emitting region includes a compound having a pyrene skeleton as a host material. The examples of the compound having a pyrene skeleton includes, but not limited to, the following materials.

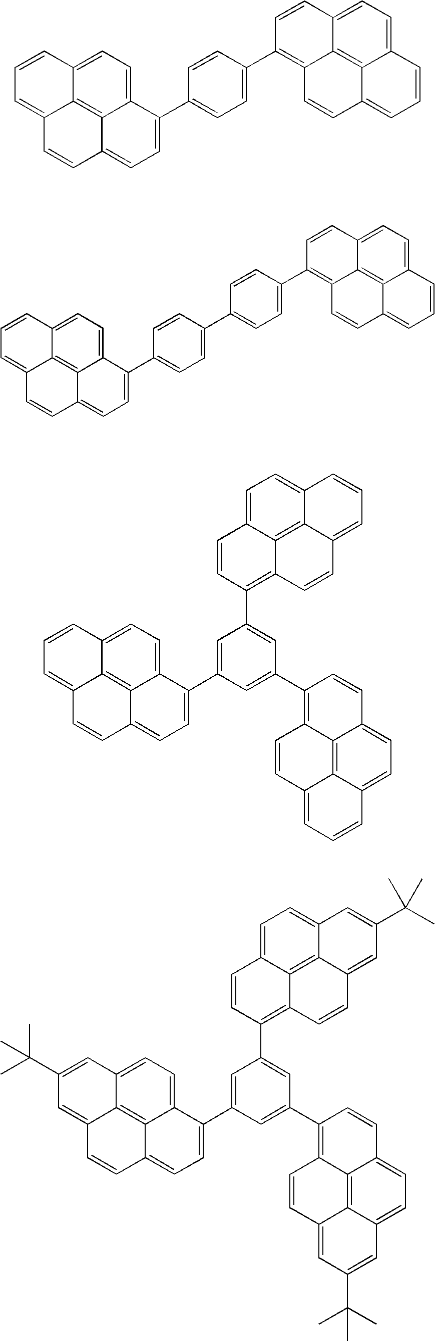

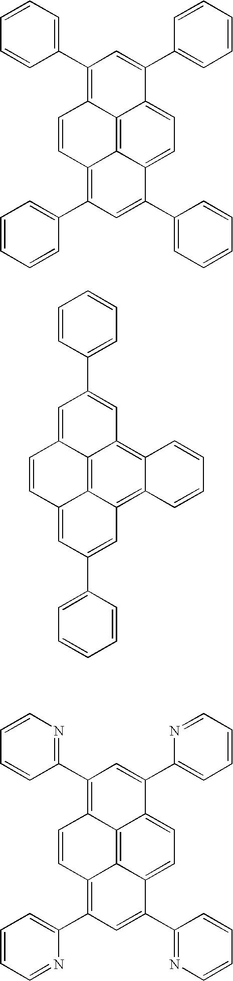

Investigation conducted by the inventors of the present invention has revealed that, in general, a pyrene skeleton material is particularly excellent in electron transport property (that is, the material has a large electron mobility and a smaller hole mobility as compared to the electron mobility). In particular, a material having a high electron mobility of 1×10⁻⁴ cm²/Vs or more can be easily obtained. Therefore, when a light-emitting layer is formed of the material, a device can be driven at a low voltage, so that power efficiency can be improved. In this case, however, there has been a tendency that carrier balance between electrons and holes in the light-emitting layer is disturbed or that a light-emitting region is extremely deviated to the interface of the light-emitting layer on an anode side. Accordingly, a reduction in emission efficiency of the device, or the deterioration of the device due to continuous driving became in some cases.

In addition, a pyrene skeleton material can be used also as a light-emitting material for a blue color region. However, the material generally tends to show the large broadening of an emission spectrum due to molecular aggregation, so that the material has been disadvantageous for obtaining pure blue-light emission.

To alleviate the above-mentioned various problems, in the present invention, the light-emitting layer is doped with a compound having a fluoranthene skeleton as a luminescent dopant. Further, a lowest unoccupied molecular orbital (LUMO) energy EL1 of the luminescent dopant material and a lowest unoccupied molecular orbital energy EL2 of the host material satisfy the relationship of EL2−EL1≧0.15 eV. Here, the lowest unoccupied molecular orbital energy of an ordinary molecule has a negative value.

Since the lowest unoccupied molecular orbitals involved in electron transport satisfy the above-mentioned relationship, the luminescent dopant functions as an electron trap, so that the electron transport performance of the light-emitting layer becomes lower than that of the host material alone. That is, the electron mobility of the light-emitting layer becomes smaller than that of the host material alone. As a result, the disturbance of a carrier balance and the extreme deviation of the light-emitting region are alleviated. It is desirable that the electron mobility of the light-emitting layer be reduced by one or more orders of magnitude owing to the electron trap. That is, an electron mobility μE of the light-emitting layer and an electron mobility μH of the host material alone desirably satisfy the relationship of μE/μH≦0.1.

According to the investigation based on carrier mobility measurement conducted by the inventors of the present invention, a sufficient electron trap effect cannot be obtained when the relationship of EL2−EL1<0.15 eV is established.

In addition, a highest occupied molecular orbital (HOMO) energy EHH of the host material and a highest occupied molecular orbital energy EHD of the luminescent dopant material desirably satisfy the relationship of EHH−EHD>0 eV. Here, the highest occupied molecular orbital energy of an ordinary molecule has a negative value. A hole in the light-emitting layer is not trapped in the luminescent dopant, so hat the hole transport performance of the light-emitting layer does not largely differ from that of the host material alone.

In contrast, when a hole is trapped in the luminescent dopant, the hole transport performance of the light-emitting layer becomes lower than that of the host material alone, so that balance between electrons and holes is additionally disturbed.

According to the present invention, the deviation of the light-emitting region in the light-emitting layer is alleviated on the basis of such principle as described above, whereby the light-emitting region expands in the light-emitting layer. The fact means that a part of electrons injected into the light-emitting layer reach the interface of the light-emitting layer on an anode side while part of holes reach the interface of the light-emitting layer on a cathode side. Therefore, the organic light-emitting device of the present invention has a particularly preferably structure in which a hole transport layer is arranged on the anode side of the light emitting layer, and an electron transport layer is arranged on the cathode side of the light-emitting layer so that the layers can confine an electron and a hole in the light-emitting layer.

Even in a case of a light-emitting layer emitting blue light, the energy gap of a hole transport material constituting a hole transport layer in contact with the light-emitting layer is preferably larger than 3.15 eV in order that an electron and a hole may be effectively confined. In addition, the energy gap of an electron transport material constituting an electron transport layer in contact with the light-emitting layer is preferably larger than 3.00 eV.

In addition, when a material having a fluoranthene skeleton is used as a luminescent dopant, blue light having a spectral bandwidth narrower than that of a host material having a pyrene skeleton can be easily emitted.

Examples of a luminescent dopant having a fluoranthene skeleton include, but not limited to, the following materials.

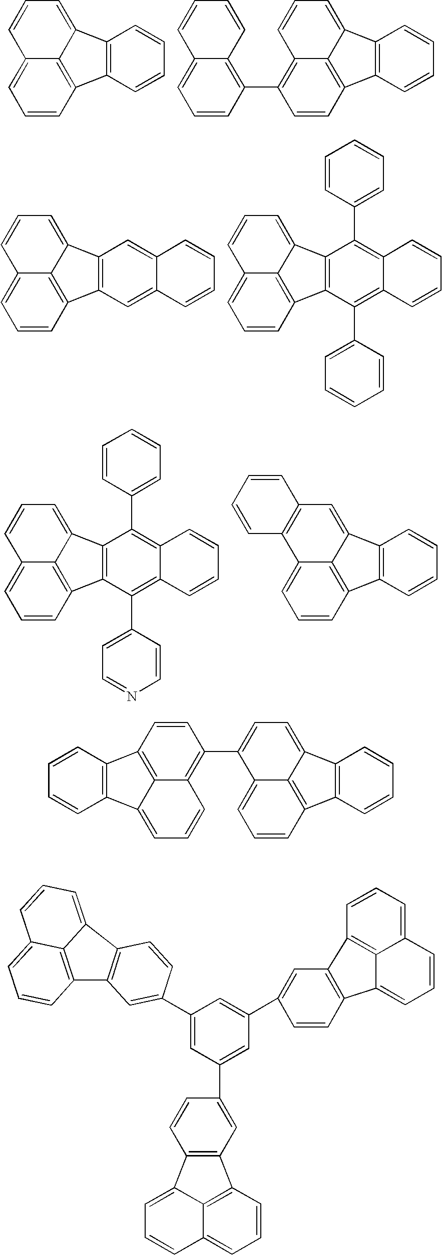

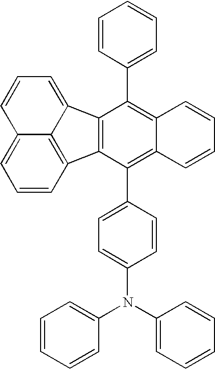

The host material preferably has a fluorene skeleton in addition to the pyrene skeleton. The host material particularly preferably has any one of the structures represented by the following general formulae (1) to (3):

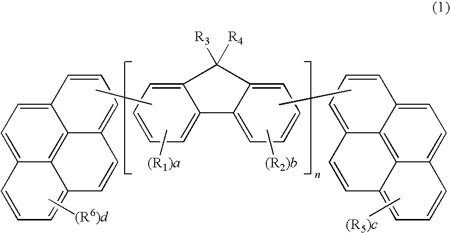

wherein R₁ and R₂ groups each represent a hydrogen atom, a substituted or unsubstituted alkyl group, a substituted or unsubstituted aralkyl group, a substituted or unsubstituted aryl group, a substituted or unsubstituted heterocyclic group, a substituted amino group, a cyano group, or a halogen atom; R₁ groups bonded to different fluorenediyl groups or R₂ groups bonded to different fluorenediyl groups may be the same or different, and R₁ groups bonded to the same fluorenediyl group, R₂ groups bonded to the same fluorenediyl group, or R₁ and R₂ groups bonded to the same fluorenediyl group may be the same or different;

R₃ and R₄ groups each represent a hydrogen atom, a substituted or unsubstituted alkyl group, a substituted or unsubstituted aralkyl group, a substituted or unsubstituted aryl group, or a substituted or unsubstituted heterocyclic group; R₃ groups bonded to different fluorenediyl groups, or R₄ groups bonded to different fluorenediyl groups may be the same or different, and R₃ and R₄ groups bonded to the same fluorenediyl group may be the same or different;

R₅ and R₆ groups each represent a hydrogen atom, a substituted or unsubstituted alkyl group, a substituted or unsubstituted aralkyl group, a substituted or unsubstituted aryl group, a substituted or unsubstituted heterocyclic group, a substituted amino group, a cyano group, or a halogen atom; R₅ groups, R₆ groups, or R₅ and R₆ groups may be the same or different; and

a and b each represent an integer of 1 to 3 and may be the same or different, c and d each represent an integer of 1 to 9 and may be the same or different, and n represents an integer of 1 to 10;

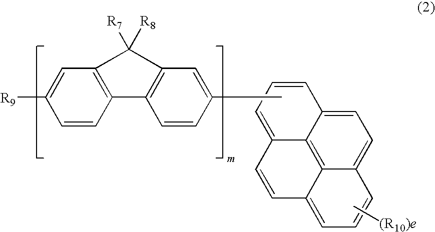

wherein R₇ groups and R₈ groups each represent a hydrogen atom, a substituted or unsubstituted alkyl group, a substituted or unsubstituted aralkyl group, a substituted or unsubstituted aryl group, or a substituted or unsubstituted heterocyclic group, and R₇ groups and R₈ groups may be the same or different;

R₉ group represents a hydrogen atom, a linear, branched, or cyclic alkyl group (one or more methylene groups of the alkyl group may be substituted by —O—, —S—, —CO—, —CO—O—, —O—CO—, —CH═CH—, —C≡C—, an arylene group that may have a substituent, or a heterocyclic group that may have a substituent, and a hydrogen atom in the alkyl group may be substituted by a fluorine atom) or a substituted or unsubstituted aryl group which has 2 or less rings (one or more CH groups of the aryl group may be substituted by an N atom;

R₁₀ group represents a hydrogen atom, a substituted or unsubstituted alkyl group, a substituted or unsubstituted aralkyl group, a substituted or unsubstituted aryl group, a substituted or unsubstituted heterocyclic group, a substituted amino group, or a halogen atom;

e represents an integer of 1 to 9, and when a plurality of R₁₀ groups are present, the plurality of R₁₀ groups may be the same or different; and

m represents an integer of 2 to 10, and a plurality of fluorenediyl groups may be the same or different; and

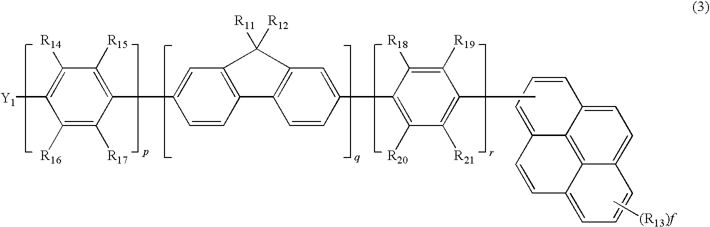

wherein R₁₁, and R₁₂, and R₁₄ to R₂₁ groups each represent a hydrogen atom, a substituted or unsubstituted alkyl group, a substituted or unsubstituted aralkyl group, a substituted or unsubstituted aryl group, or a substituted or unsubstituted heterocyclic group, and R₁₁ and R₁₂ groups may be the same or different;

Y₁ group represents a hydrogen atom or a substituted or unsubstituted fused ring structure composed of hydrocarbon;

q represents an integer of 1 to 10, and when q represents 2 or more, a plurality of fluorenediyl groups may be the same or different;

p means a number of a repeating structure of substituted or unsubstituted phenyl groups, and represents zero or an integer of 1 to 20;

r means a number of a repeating structure of substituted or unsubstituted phenyl groups, and represents an integer of 1 to 20; and

R₁₃ group represents a hydrogen atom, a substituted or unsubstituted alkyl group, a substituted or unsubstituted aralkyl group, a substituted or unsubstituted aryl group, a substituted or unsubstituted heterocyclic group, a substituted amino group, or a halogen atom, f represents an integer of 1 to 9, and when a plurality of R₁₃ groups are present, the plurality of R₁₃ groups may be the same or different.

In the formulae (1) to (3), examples of an alkyl group include a methyl group, an ethyl group, a normal propyl group, an isopropy group, a normal butyl group, a teriary butyl group, a secondary butyl group, an octyl group, a 1-adamantyl group, and a 2-adamantyl group.

Examples of an aralkyl group include a benzyl group and a phenethyl group.

Examples of an aryl group include a phenyl group, a naphthyl group, a pentalenyl group, an indenyl group, an azulenyl group, an anthryl group, a pyrenyl group, an indacenyl group, an acenaphthenyl group, a phenanthryl group, a phenalenyl group, a fluororanthenyl group, an acephenanthryl group, an aceanthryl group, a triphenylenyl group, a chrysenyl group, a naphthacenyl group, a perylenyl group, a pentacenyl group, a biphenyl group, a terphenyl group, and a fluolenyl group.

Examples of a heterocyclic group include a thienyl group, a pyrrolyl group, a pyridyl group, an oxazolyl group, an oxadiazolyl group, a thiazolyl group, a thiadiazolyl group, a terthienyl group, a carbazolyl group, an acridinyl group, and a phenanthrolyl group.

Examples of a substituted amino group include a dimethylamino group, a diethylamino group, a dibenzylamino group, diphenylamino group, a ditolylamino group, and a dianisolylamino group.

Examples of a halogen atom include fluorine, chlorine, bromine, and iodine.

Examples of a substituent which the above-mentioned substituents each may have include an alkyl group such as a methyl group, an ethyl group, or a propyl group; an aralkyl group such as a benzyl group or a phenethyl group; an aryl group such as a phenyl group or biphenyl group; a heterocyclic group such as a thienyl group, a pyrrolyl group, or a pyridyl group; an amino group such as a dimethylamino group, a diethylamino group, a dibenzylamino group, a diphenylamino group, a ditolylamino group, or a dianisolylamino group; an alkoxyl group such as a methoxyl group, an ethoxyl group, a propoxyl group, or a phenoxyl group; a cyano group; and a halogen atom such as fluorine, chlorine, bromine, or iodine.

Specific examples of the general formula (1) include, but not limited to, the following structures.

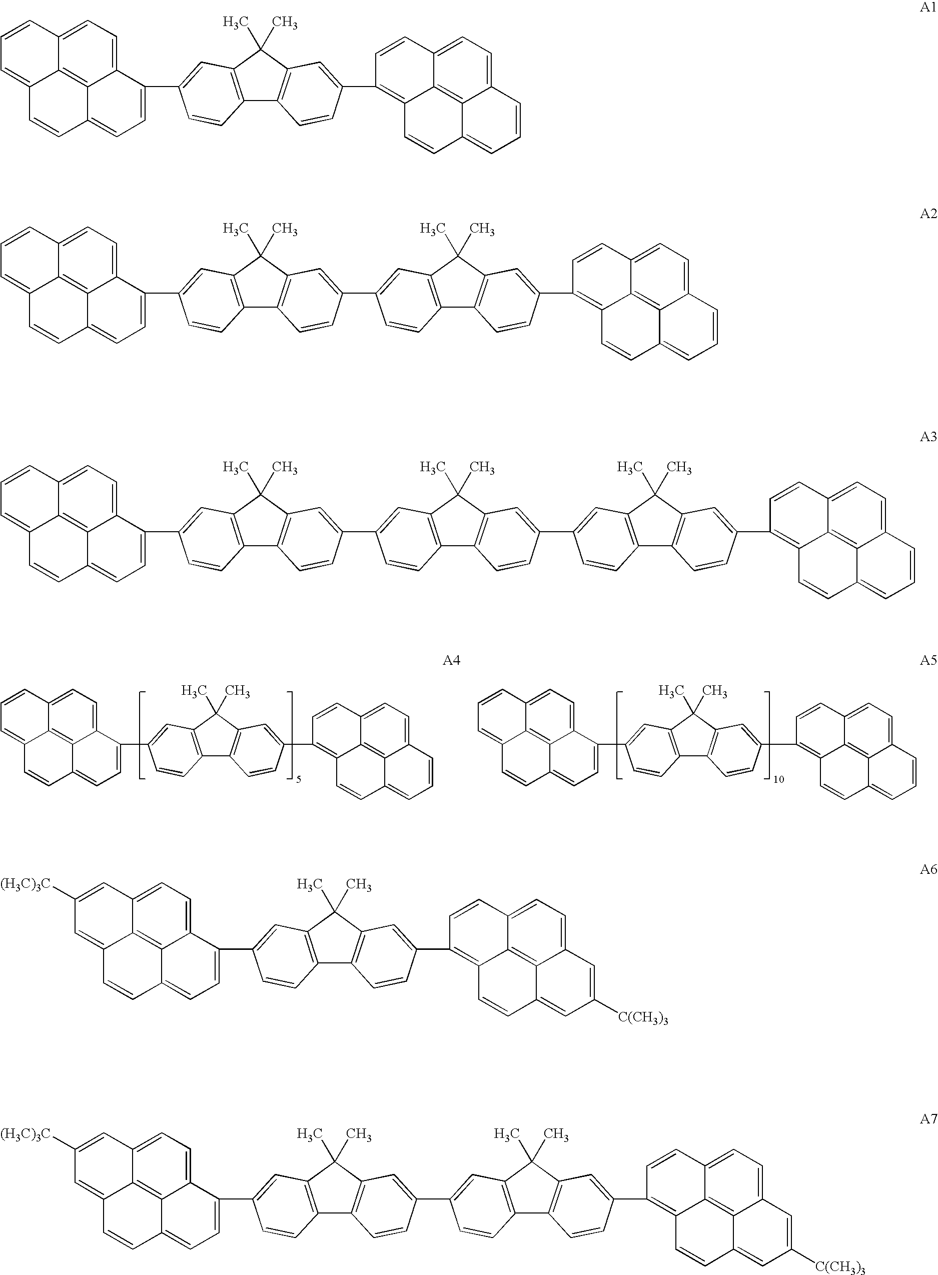

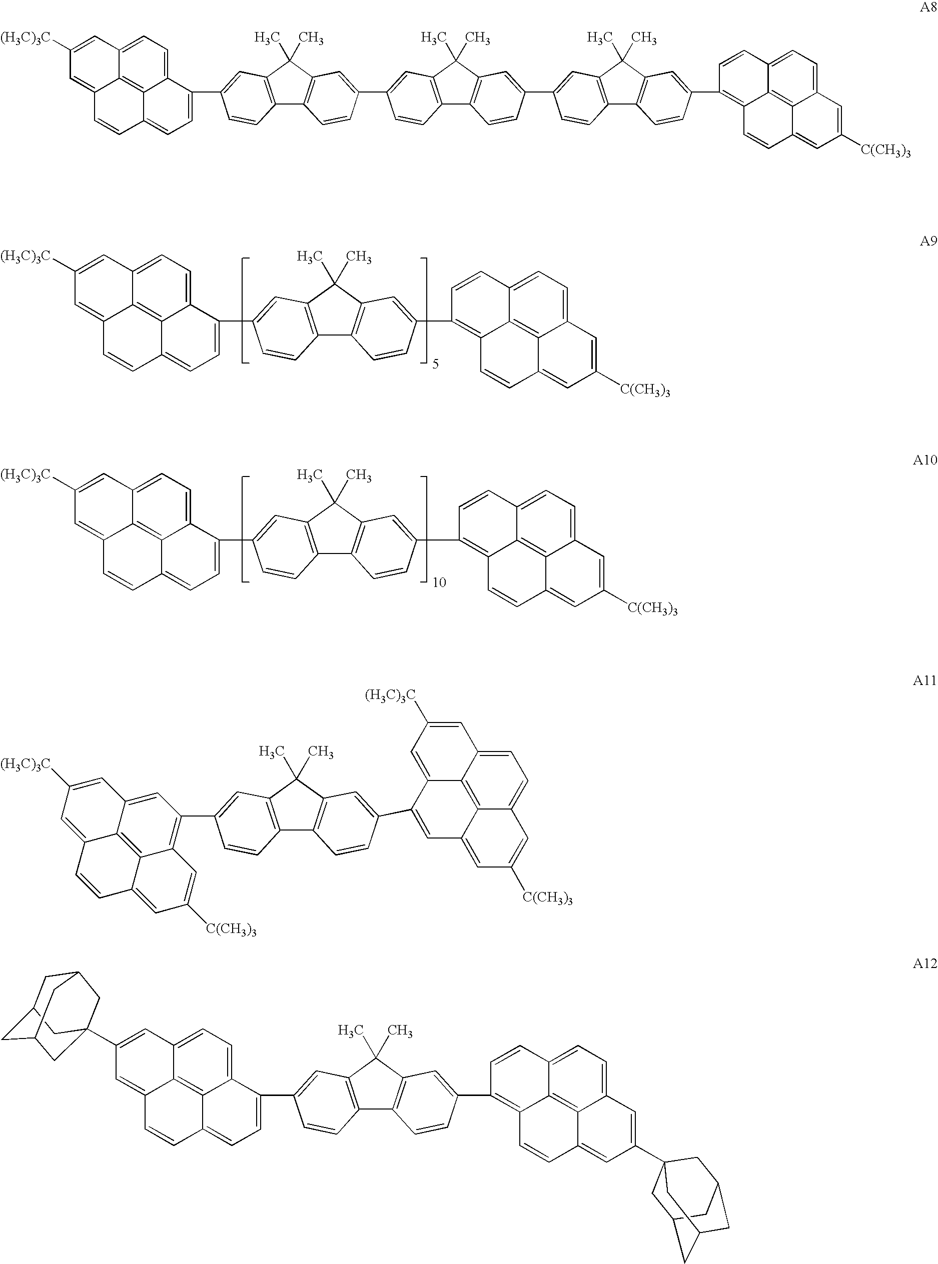

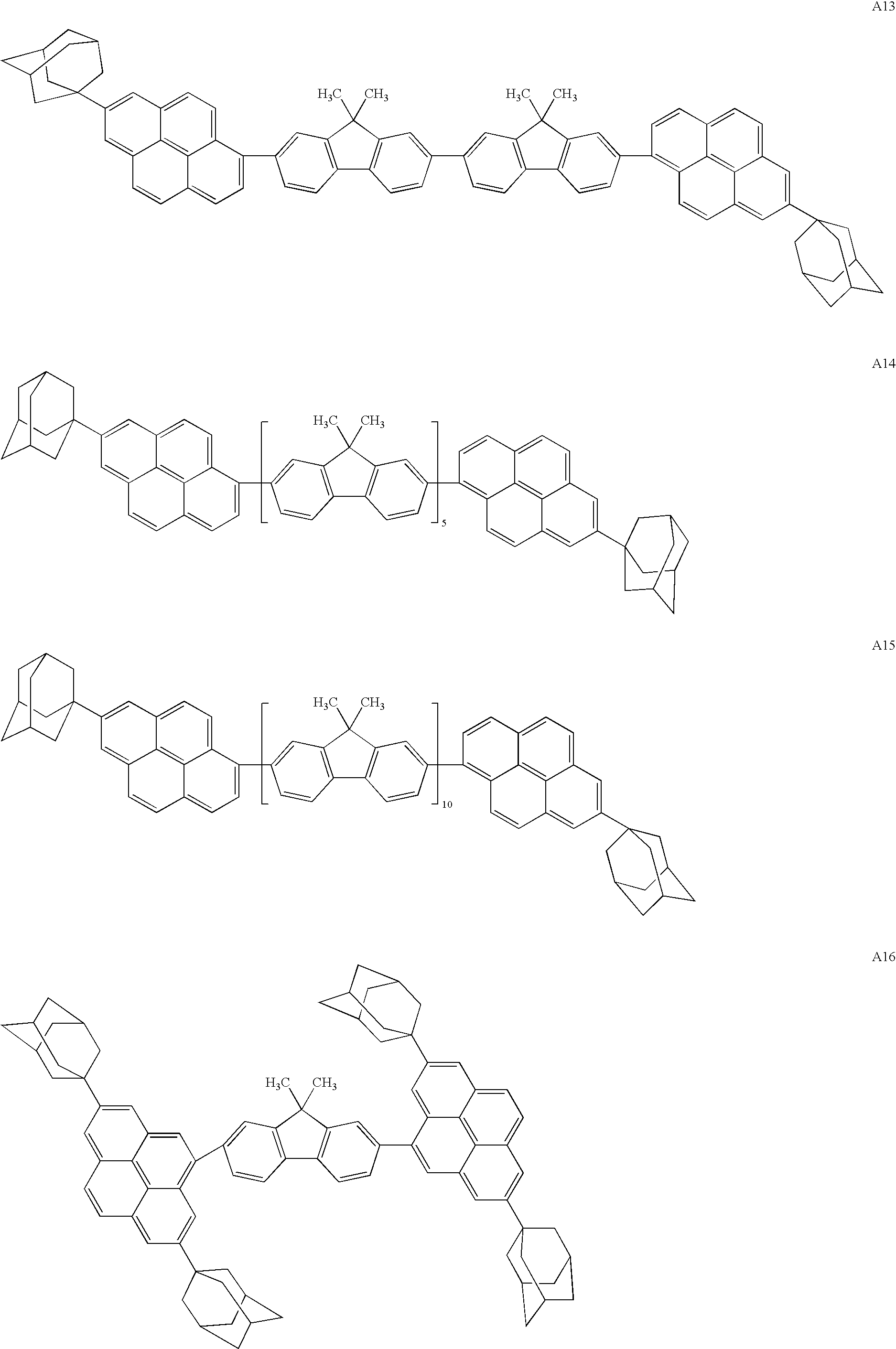

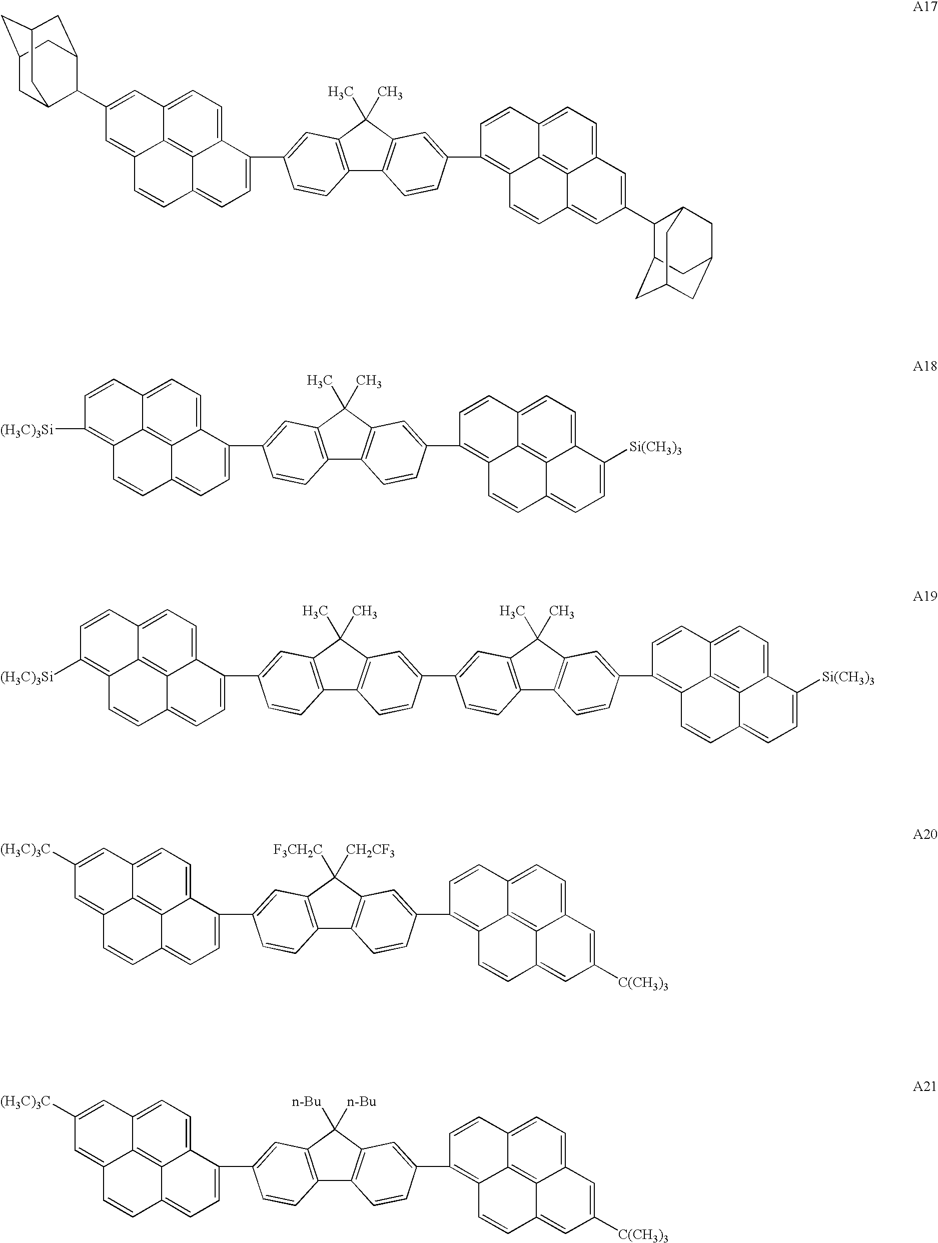

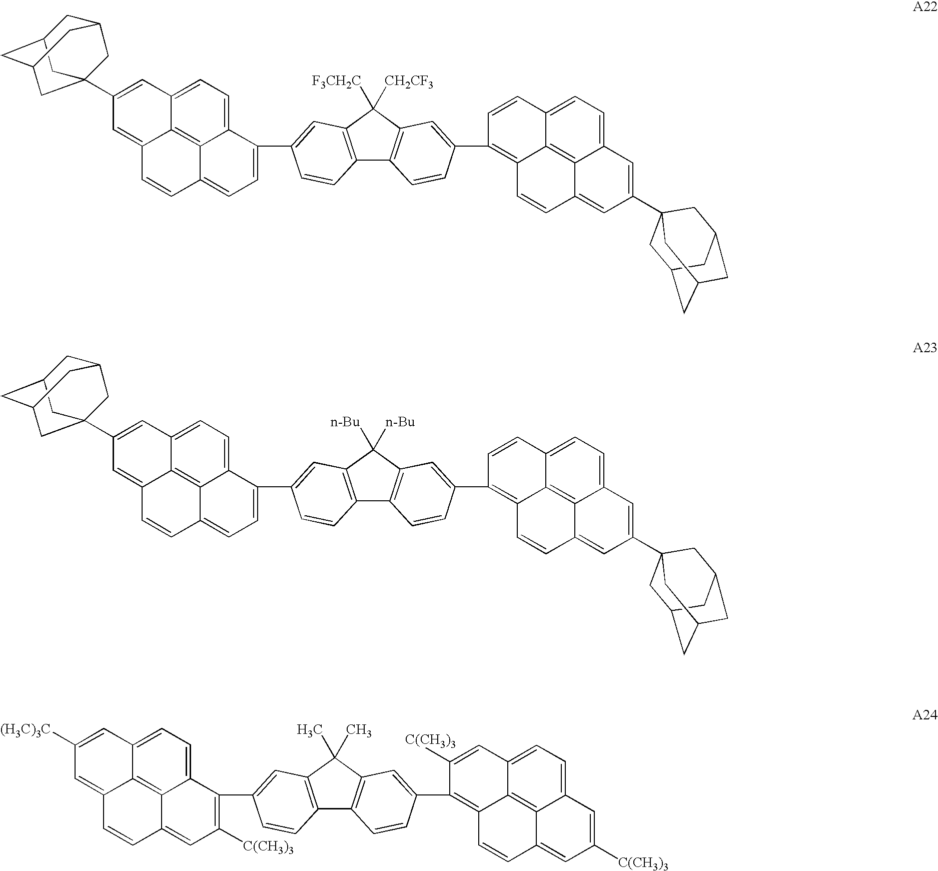

Specific examples of the general formula (2) include, but not limited to, the following structures

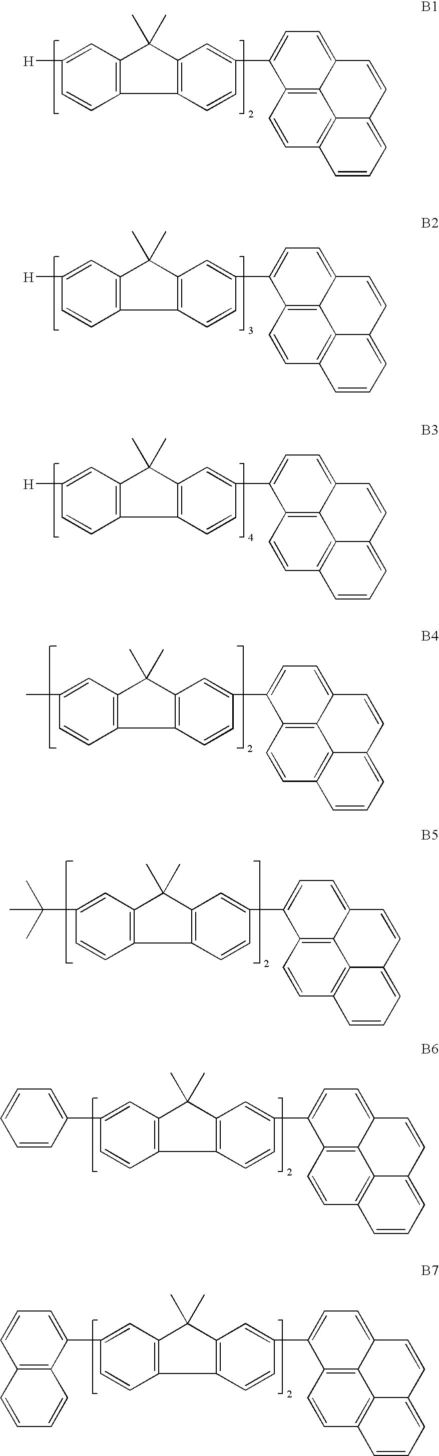

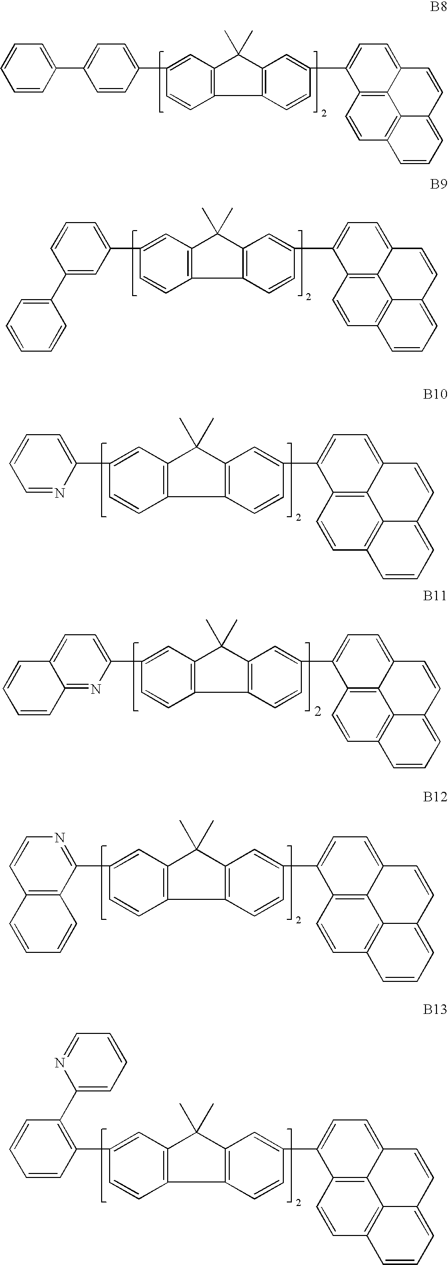

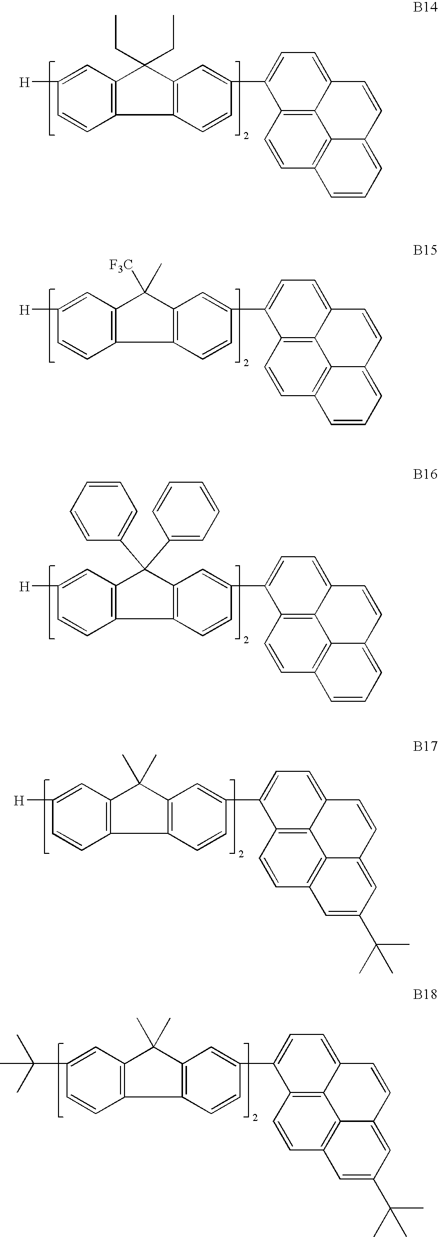

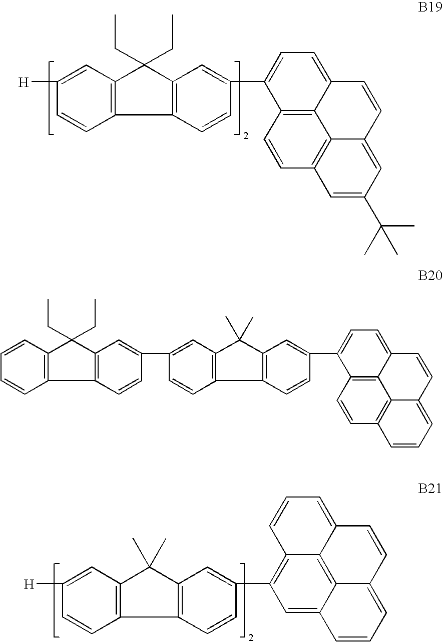

Specific examples of the general formula (3) include, but not limited to, the following structures.

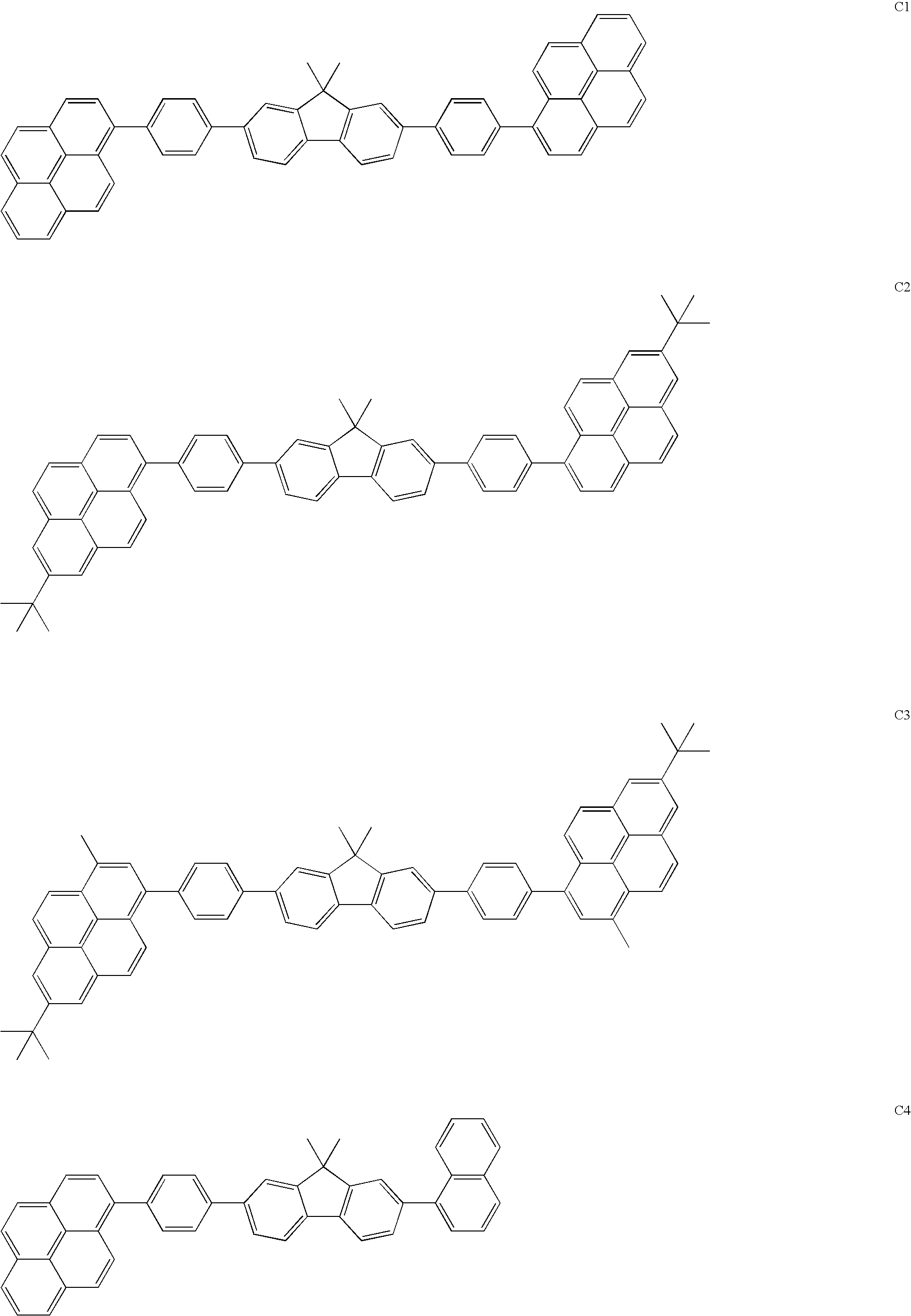

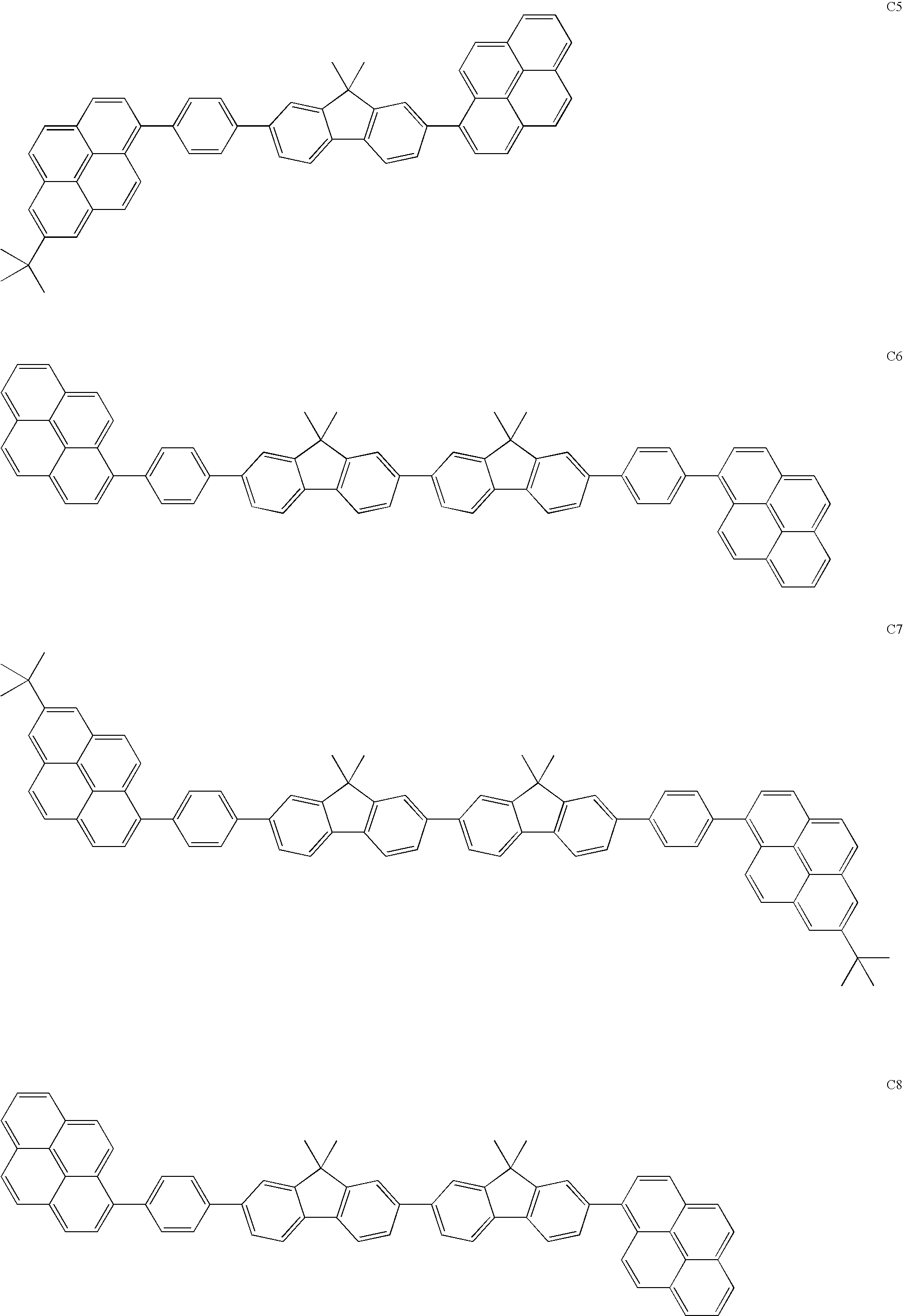

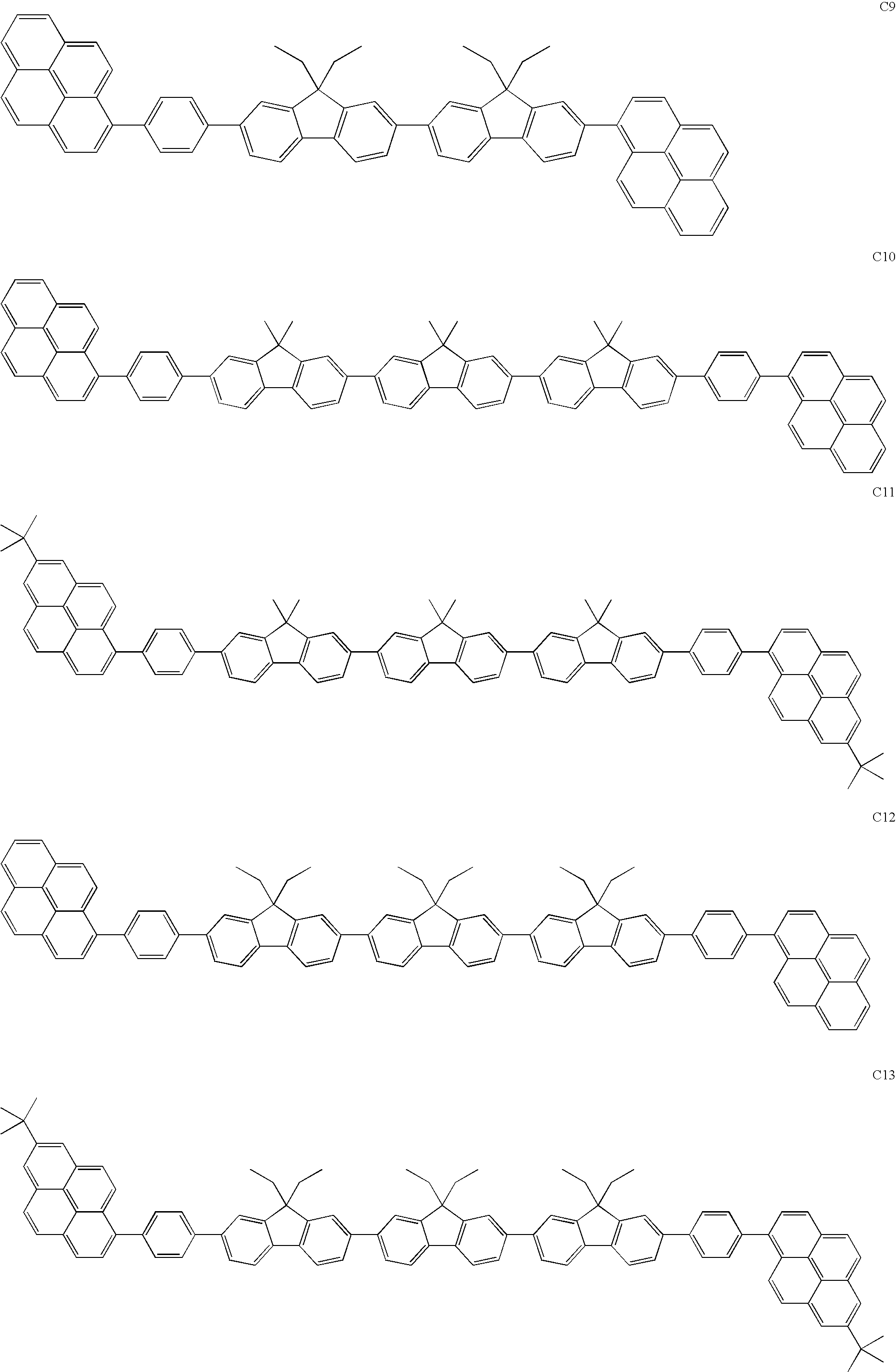

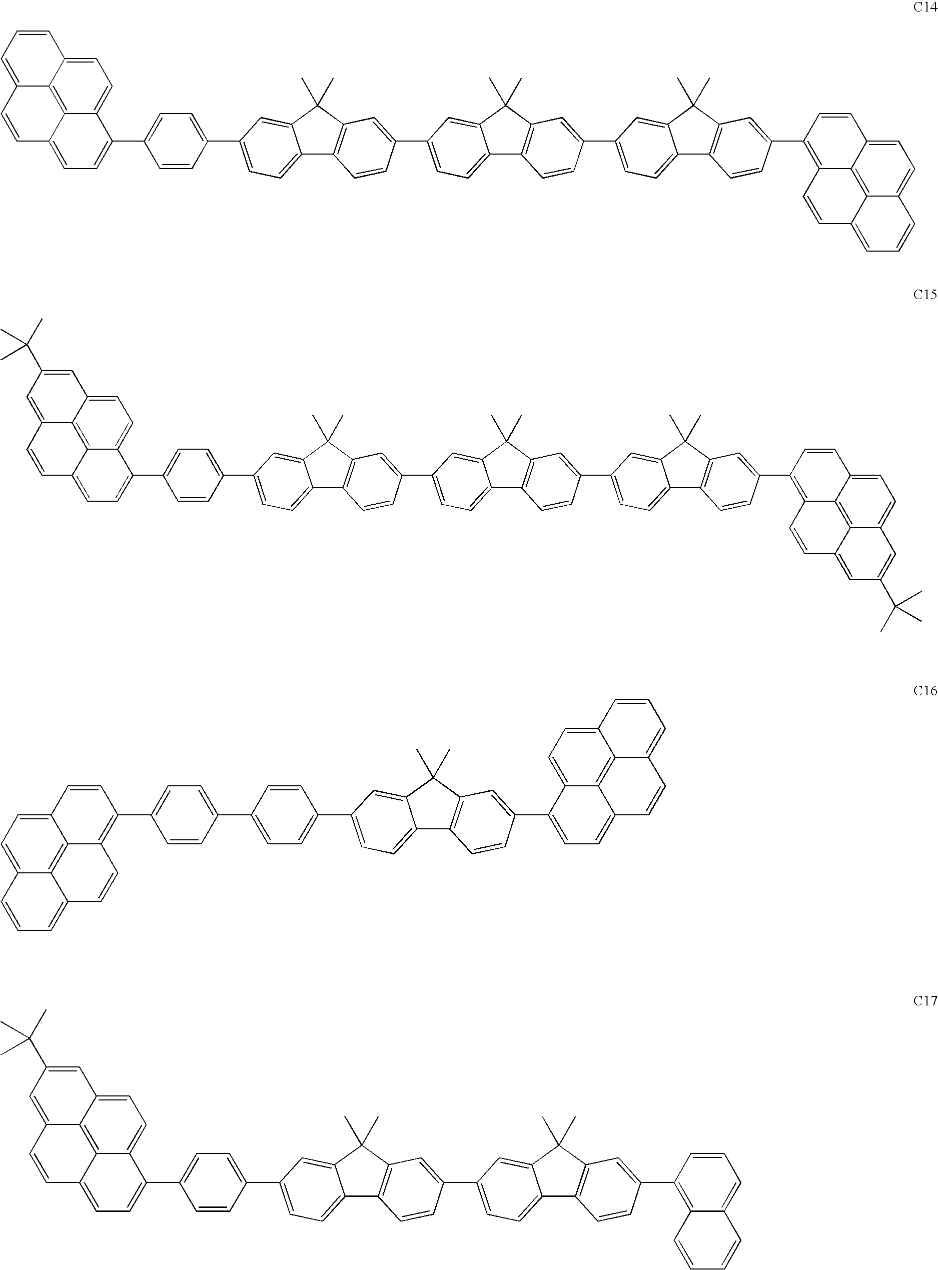

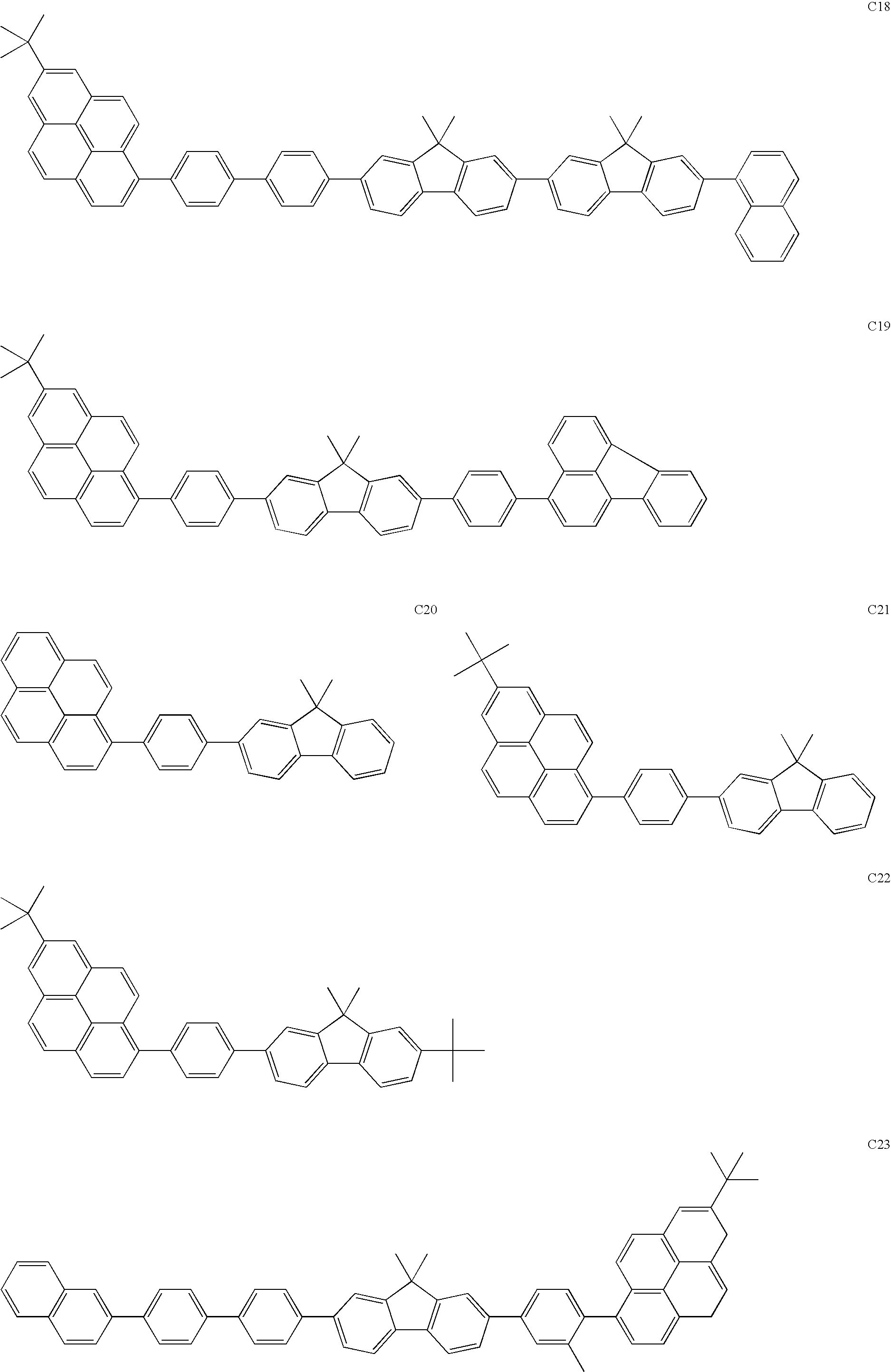

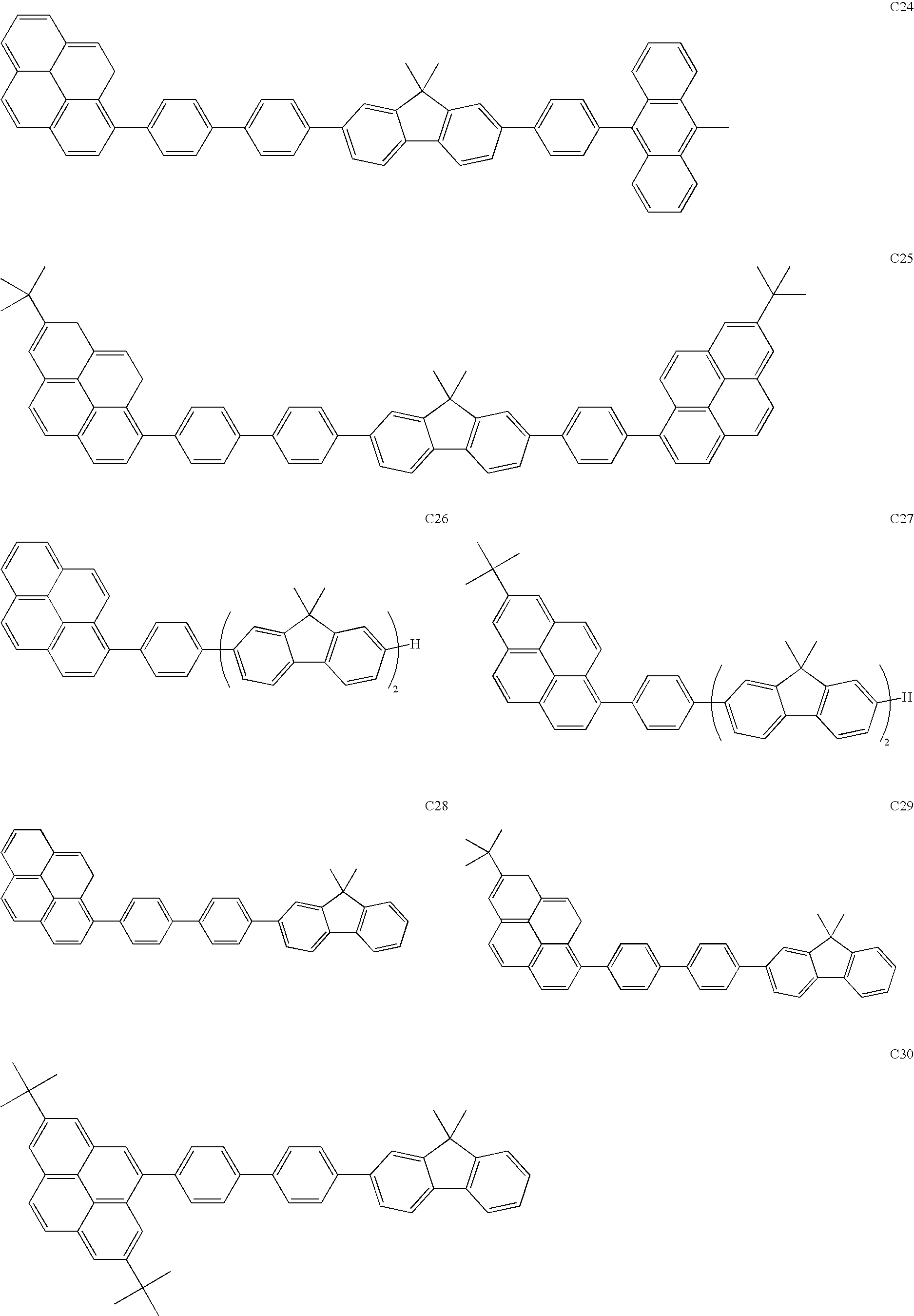

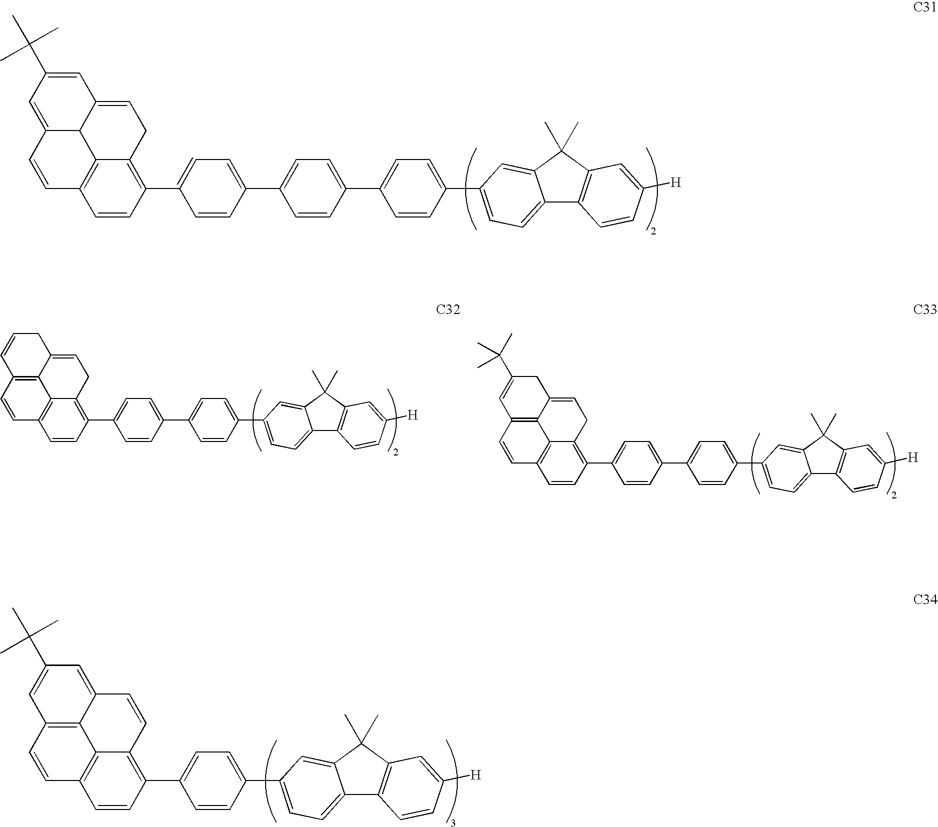

The host material of the present invention which is represented by any one of the general formulae (1) to (3) can obtain the following excellent properties because of its molecular structure:

(1) the host material is extremely excellent in amorphous property, and has high heat resistance;
(2) each of both an electron and a hole can easily obtain a suitable carrier injection level; and
(3) the host material can easily obtain an energy gap optimum for blue light emission, that is, an energy gap of 2.7 eV or more to 3.4 eV or less.

Further, a combination of the host material and the luminescent dopant having a fluoranthene skeleton can easily provide the following excellent properties:

(4) energy favorably transfers from the host to the dopant, provided that it is important for an energy gap E1 of the luminescent dopant and an energy gap E2 of the host-material to satisfy the relationship of E1<E2; and
(5) compatibility between the host having a pyrene skeleton and the luminescent dopant having a fluoranthene skeleton is so high that the luminescent dopant is favorably dispersed in a light-emitting layer, whereby reductions in efficiency and lifetime of a light-emitting device resulting from the aggregation of the luminescent dopant can be alleviated, provided that particularly good result can be obtained when the host material and the luminescent dopant are each a hydrocarbon compound, and of the above-mentioned host materials, a material having a sum of the number of pyrene skeletons and the number of fluorene skeletons in one molecule of 3 or 4 is particularly preferable in order that such material has together an excellent electron mobility, excellent amorphous property, and excellent property in film formation by evaporation.

In addition, a luminescent dopant having a fluoranthene skeleton and a fluorene skeleton is particularly good, and is preferably combined with a host material represented by any one of the general formulae (1) to (3). This is because both the luminescent dopant and the host contain the same fluorene skeleton. Examples of the luminescent dopant having a fluoranthene skeleton and a fluorene skeleton include, but not limited to, the following materials.

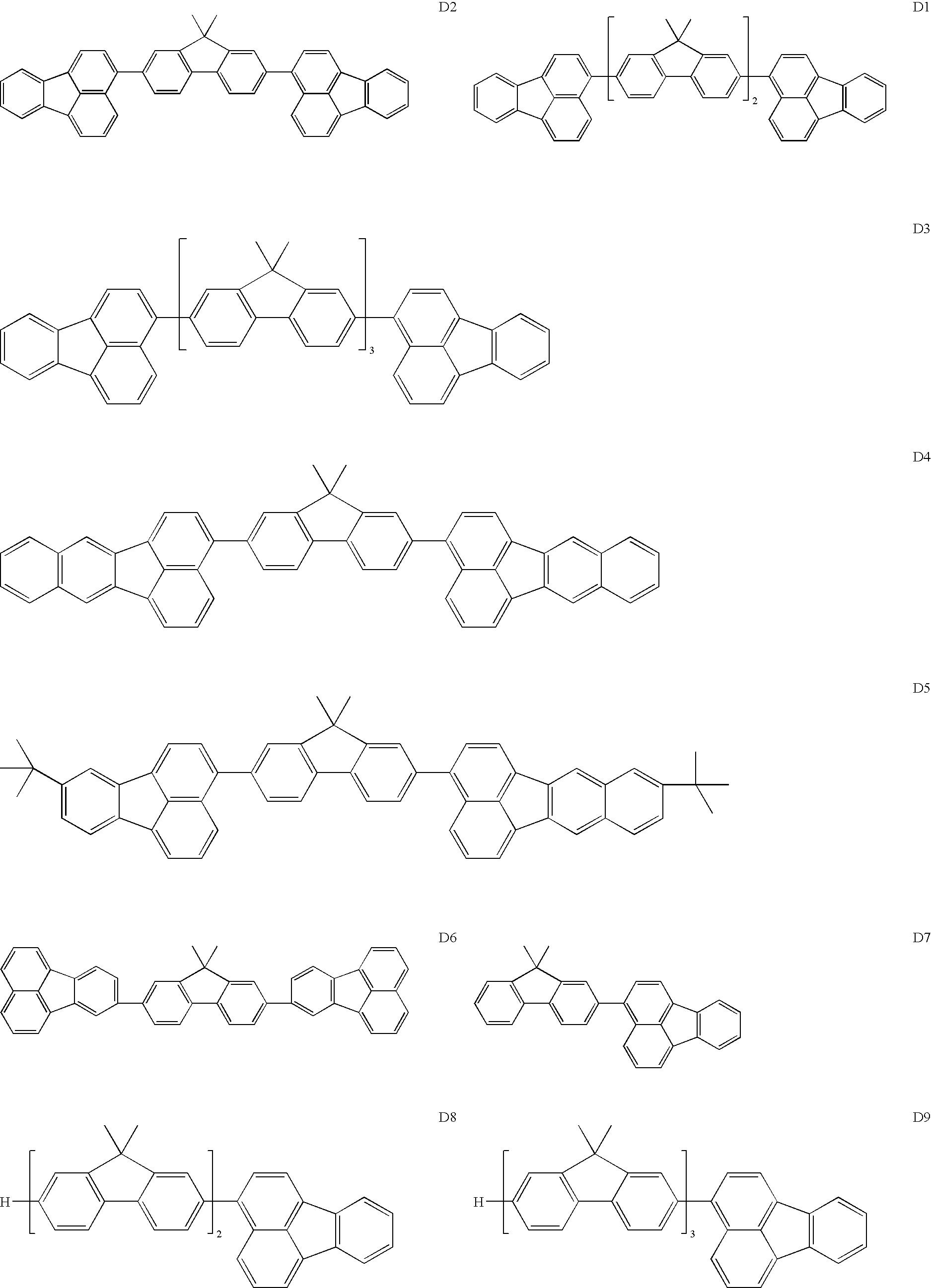

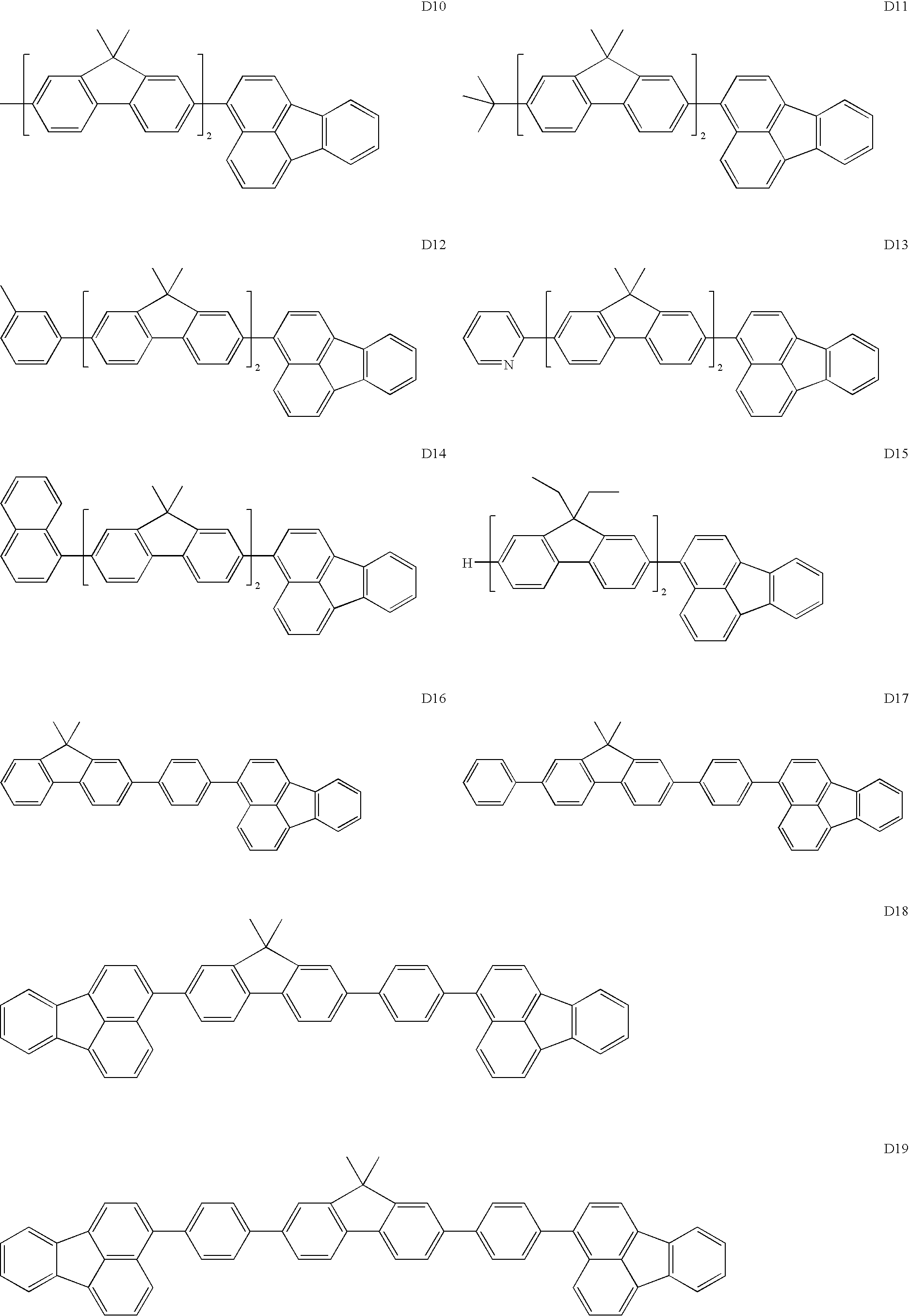

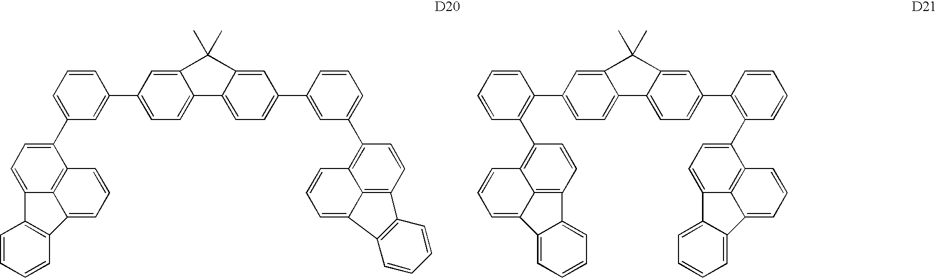

In the present invention, it is desirable that the luminescent dopant containing a fluoranthene skeleton be chemically stable against reduction because an electron is trapped in the luminescent dopant. Further, the deformation of the structure of the dopant from a neutral state in a state where the electron is trapped is preferably small. A LUMO is considered to be preferably delocalized in a relatively wide region in a molecule in order that the deformation may be small.

The luminescent dopant is mixed in the light-emitting layer at a concentration of preferably 0.1 wt % or more to 35 wt % or less, or more preferably 1 wt % or more to 15 wt % or less in consideration of the electron trap mechanism and the energy transfer from the host to the luminescent dopant described above.

An energy gap can be determined from measurement of a visible light-ultraviolet absorption spectrum. In the present invention, the energy gap was determined from an absorption edge of a thin film formed on a glass substrate by using a spectrophotometer U-3010 manufactured by Hitachi, Ltd. as a device.

An ionization potential and a highest occupied molecular orbital (HOMO) energy were measured by employing photoelectron spectroscopy in the air (measuring instrument name AC-1 manufactured by RIKENKIKI CO., LTD).

An electron affinity and a lowest unoccupied molecular orbital (LUMO) energy can be calculated from the measured value for the energy gap and the above-mentioned HOMO energy. In the present invention, a method of calculating the LUMO energy from the value for the HOMO energy and the energy gap was employed. That is, LUMO energy=HOMO energy+energy gap.

In addition, a carrier mobility can be measured by a transient current measurement using a time-of-flight (TOF) method. In the present invention, a thin film having a thickness of about 2 μm was produced on a glass substrate with ITO by a vacuum evaporation method, and, furthermore, aluminum was deposited to serve as a counter electrode. A value for the carrier mobility of the sample at an electric field intensity of 4×10⁵ V/cm was measured by using a TOF measuring apparatus (TOF-301 manufactured by OPTEL).

A hole transportable material preferably has excellent mobility for facilitating the injection of a hole from an anode and transporting the injected hole to a light-emitting layer. Examples of a low-molecular-weight material and a high-molecular-weight material each having hole injection/transport performance include, but of course not limited to, a triarylamine derivative, a phenylenediamine derivative, a triazole derivative, an oxadiazole derivative, an imidazole derivative, a pyrazoline derivative, a pyrazolone derivative, an oxazole derivative, a fluorenone derivative, a hydrazone derivative, a stilbene derivative, a phthalocyanine derivative, a porphyrin derivative, poly(vinylcarbazole), poly(silylene), poly(thiophene), and any other conductive polymer.

An electron injectable/transportable material can be arbitrarily selected from materials each having a function for facilitating the injection of an electron from a cathode and transporting the injected electron to the light-emitting layer, and is selected in consideration of, for example, a balance between the carrier mobility of the material and the carrier mobility of a hole transport material. Examples of a material having electron injection/transport performance include, but of course not limited to, an oxadiazole derivative, an oxazole derivative, a thiazole derivative, a thiadiazole derivative, a pyrazine derivative, a triazole derivative, a triazine derivative, a perylene derivative, a quinoline derivative, a quinoxaline derivative, a fluorenone derivative, an anthrone derivative, a phenanthroline derivative, and an organometallic complex. In addition, a material having a large ionization potential can be used also as a hole block material.

A layer composed of an organic compound in the organic light-emitting device of the present invention is obtained by any one of various methods. In general, a thin film is formed by a vacuum evaporation method, an ionized evaporation method, sputtering, or plasma CVD. Alternatively, a thin film is formed by: dissolving a material for the film in an appropriate solvent, and subjecting the solution to a known application method (such as a spin coating method, a dipping method, a cast method, an LB method, or an ink-jet method). In particular, when a film is formed by the application method, the film can be formed in combination with an appropriate binder resin.

The above-mentioned binder resin can be selected from a wide variety of binding resins, and examples of the binder resin include, but not limited to, a polyvinyl carbazole resin, a polycarbonate resin, a polyester resin, a polyallylate resin, a polystyrene resin, an ABS resin, a polybutadiene resin, a polyurethane resin, an acrylic resin, a methacrylic resin, a butyral resin, a polyvinyl acetal resin, a polyamide resin, a polyimide resin, a polyethylene resin, a polyether sulfone resin, a diallyl phthalate resin, a phenol resin, an epoxy resin, a silicone resin, a polysulfone resin, and a urea resin. In addition, one kind of them may be used alone, or two or more kinds of them may be mixed to serve as a copolymer. Further, as required, a known additive such as a plasticizer, an antioxidant, or a UV absorber may be used in combination with the binder resin.

A material for the anode desirably has as large a work function as possible, and examples of a material that can be used include: metal elements such as gold, platinum, silver, copper, nickel, palladium, cobalt, selenium, vanadium, and tungsten, or alloys of the metal elements; and metal oxides such as tin oxide, zinc oxide, indium oxide, indium tin oxide (ITO), and indium zinc oxide. A conductive polymer such as polyaniline, polypyrrole, polythiophene, or polyphenylene sulfide can also be used. Each of those electrode substances can be used alone, or two or more of them can be used in combination. In addition, the anode may be constituted of a single layer, or may be constituted of a plurality of layers.

On the other hand, a material for the cathode desirably has as small a work function as possible, and examples of a material that can be used include: metal elements such as lithium, sodium, potassium, calcium, magnesium, aluminum, indium, ruthenium, titanium, manganese, yttrium, silver, lead, tin, and chromium; and alloys each composed of two or more of the metal elements such as a lithium-indium alloy, a sodium-potassium alloy, a magnesium-silver alloy, an aluminum-lithium alloy, an aluminum-magnesium alloy, and a magnesium-indium alloy. A metal oxide such as indium tin oxide (ITO) can also be used. Each of those electrode substances can be used alone, or two or more of them can be used in combination. In addition, the cathode may be constituted of a single layer, or may be constituted of a plurality of layers.

In addition, at least one of the anode and the cathode is desirably transparent or semi-transparent.

A substrate to be used in the present invention is not particularly limited, but an opaque substrate such as a metal substrate or a ceramic substrate, or a transparent substrate such as glass, quartz, or a plastic sheet is used. In addition, a color filter film, a fluorescent color conversion filter film, a dielectric reflective film, or the like can be used in the substrate to control colored light. In addition, a device can be produced by producing a thin film transistor (TFT) on the substrate and by connecting the TFT to the substrate.

Further, a two-dimensional array of TFTs to serve as pixels can be used as a display. For example, an array of light-emitting pixels for three colors, that is, red, green, and blue colors can be used as a full-color display.

In addition, with regard to the direction of extracting light from the device, both a bottom emission constitution (constitution in which light is extracted from a substrate side) and a top emission constitution (constitution in which light is extracted from the side opposite to the substrate) are available.

The produced device may be provided with a protective layer or a sealing layer for the purpose of preventing the device from contacting with, for example, oxygen or moisture. Examples of the protective layer include a diamond thin film; an inorganic material film made of, for example, a metal oxide or a metal nitride; a polymer film such as a fluorine resin, polyparaxylene, polyethylene, a silicone resin, or a polystyrene resin; and a photocurable resin. In addition, the device itself can be covered with glass, a gas impermeable film, a metal, or the like, and the device itself can be packaged with an appropriate sealing resin.

Hereinafter, the present invention will be described more specifically by way of the following Examples. However, the present invention is not limited to these Examples.

### EXAMPLE 1

Indium tin oxide (ITO) was formed into a film having a thickness of 130 nm by a sputtering method to serve as an anode on a glass substrate as a substrate, and the resultant was used as a transparent, conductive supporting substrate. The resultant was subjected to ultrasonic cleaning in acetone and isopropyl alcohol (IPA) sequentially, and was then subjected to boiling cleaning in IPA, followed by drying. Further, the resultant was subjected to UV/ozone cleaning.

A chloroform solution was prepared by using Compound 1 shown below as a hole transport material in such a manner that the concentration of the compound would be 0.1 wt %.

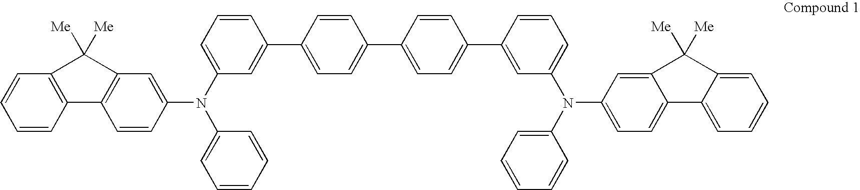

The solution was dropped onto the above-mentioned ITO electrode, and the whole was subjected to spin coating initially at a number of revolutions of 500 RPM for 10 seconds and then at a number of revolutions of 1,000 RPM for 1 minute, whereby a film was formed. After that, the resultant was dried for 10 minutes in a vacuum oven at 80° C., whereby the solvent in the thin film was completely removed. The formed hole transport layer had a thickness of 15 nm.

Next, a light-emitting layer was formed by the co-deposition of Compound 2 shown below as a host material and Compound 3 shown below as a luminescent dopant from different boats. The layer had a concentration of Compound 3 of 8 wt % and a thickness of 30 nm.

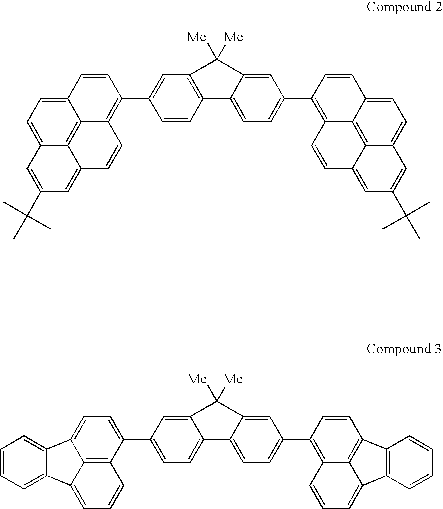

Further, Bphen shown below was subjected to vacuum deposition to form an electron transport layer. The electron transport layer had a thickness of 30 nm.

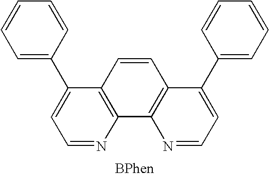

The above-mentioned organic layer was formed under conditions including: a degree of vacuum of 1.0×10⁻⁴ Pa at the time of deposition; and a film formation rate of about 0.1 nm/sec or more to 0.3 nm/sec or less.

Next, lithium fluoride (LiF) was formed into a film having a thickness of 0.5 nm on the previous organic layer by a vacuum deposition method. Further, an aluminum film having a thickness of 150 nm was provided as an electron injection electrode (cathode) on the resultant by a vacuum deposition method, whereby an organic light-emitting device was produced. The degree of vacuum at the time of the deposition was 1.0×10⁻⁴ Pa, lithium fluoride was formed into a film at a film formation rate of 0.05 nm/sec, and aluminum was formed into a film at a film formation rate of 1.0 nm/sec or more to 1.2 nm/sec or less.

The resultant organic light-emitting device was covered with a protective glass plate and sealed with an acrylic resin-based adhesive in a dry air atmosphere in order that the deterioration of the device might not occur owing to the adsorption of moisture.

A voltage of 4.5 V was applied to the thus-obtained device while the ITO electrode (anode) was used as a positive electrode and the aluminum electrode (cathode) was used as a negative electrode. As a result, the device was observed to emit blue light derived from Compound 3 and having an emission luminance of 3,800 cd/m², an emission efficiency of 5.3 lm/W, and a maximum emission wavelength of 463 nm.

Further, a voltage was applied to the device under a nitrogen atmosphere with a current density kept at 30 mA/cm². As a result, a luminance half time was as long as about 700 hours.

The thin films of the host material and luminescent dopant of the light-emitting layer were each formed by vacuum deposition, and the HOMO energy of each of the thin films was measured with a photoelectron spectrometer (apparatus name AC-1) in the air. In addition, furthermore, the energy gap and LUMO energy of each of the thin films were calculated by measuring an ultraviolet-visible light absorption spectrum (apparatus name U-3010). The result showed that the energy gap of the host material was larger than that of the luminescent dopant by 0.16 eV. In addition, the result showed that the LUMO energy EL2 of the host material was −2.72 eV, the LUMO energy EL1 of the luminescent dopant was −3.06 eV, and EL2−EL1=0.34 eV.

The energy gap of each of the hole transport material (Compound 1) and the electron transport material (BPhen) was similarly measured. The energy gap of the hole transport material was 3.25 eV, which was larger than 3.15 eV. In addition, the energy gap of the electron transport material was 3.57 eV, which was larger than 3.00 eV.

In order to measure the carrier mobility of the host material alone of the light-emitting layer, the host material (Compound 2) was formed into a layer having a thickness of 2 μm on the glass substrate with ITO by deposition. Subsequently, an aluminum film having a thickness of 150 nm was formed by a vacuum deposition method, whereby a device for mobility measurement was obtained. The surface of the formed film of the resultant device was covered with a protective glass plate in a dry air atmosphere in order that the device might be prevented from deteriorating owing to the adsorption of moisture to the surface. Then, a UV-based adhesive was loaded into a gap between the surface and the glass plate, and was cured.

The electron mobility and hole mobility of the device at an electric field intensity of 4×10⁵ V/cm were measured by using a time-of-flight measuring apparatus (TOF-301 manufactured by OPTEL). The host material had an electron mobility of 1×10⁻³ cm²/Vs and a hole mobility of 2×10⁻⁴ cm²/Vs. It was found that the electron mobility of the host material was larger than the hole mobility of the host material. It was also found that the electron mobility of the host material was larger than 1×10⁻⁴ cm²/Vs.

Next, in order to measure the carrier mobility of the light-emitting layer, the host material (Compound 2) and the luminescent dopant material (Compound 3) were formed into a layer having a thickness of 2 μm on the glass substrate with ITO by co-deposition in the same manner as in the light-emitting layer of the organic light-emitting device. Subsequently, an aluminum film having a thickness of 150 nm was formed by a vacuum deposition method, whereby a device for mobility measurement was obtained. The surface of the formed film of the resultant device was covered with a protective glass plate in a dry air atmosphere in order that the device might be prevented from deteriorating owing to the adsorption of moisture to the surface. Then, a UV-based adhesive was loaded into a gap between the surface and the glass plate, and was cured.

The electron mobility of the device at an electric field intensity of 4×10⁵ V/cm was measured by using a time-of-flight measuring apparatus (TOF-301 manufactured by OPTEL). The light-emitting layer had an electron mobility of 4×10⁻⁷ cm²/Vs. It was found that the electron mobility of the light-emitting layer was lower than that of the host material alone by one or more orders of magnitude.

### EXAMPLE 2

A light-emitting device was produced in the same manner as in Example 1 except that the host material of a light-emitting layer was constituted of Compound 4 shown below.

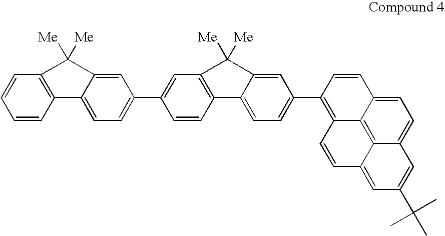

A voltage of 4.5 V was applied to the thus-obtained device while the ITO electrode (anode) was used as a positive electrode and the aluminum electrode (cathode) was used as a negative electrode. As a result, the device was observed to emit blue light derived from Compound 3 and having an emission luminance of 2,500 cd/m², an emission efficiency of 5.5 lm/W, and a maximum emission wavelength of 460 nm.

Further, a voltage was applied to the device under a nitrogen atmosphere with a current density kept at 30 mA/cm². As a result, a luminance half time was as long as about 1,400 hours.

The thin films of the host material and luminescent dopant of the light-emitting layer were each formed by vacuum deposition, and the HOMO energy of each of the thin films was measured with a photoelectron spectrometer (apparatus name AC-1) in the air. In addition, furthermore, the energy gap and LUMO energy of each of the thin films were calculated by measuring an ultraviolet-visible light absorption spectrum (apparatus name U-3010).

The result showed that the energy gap of the host material was larger than that of the luminescent dopant by 0.18 eV. In addition, the result showed that the LUMO energy EL2 of the host material was −2.64 eV, the LUMO energy EL1 of the luminescent dopant was −3.06 eV, and EL2−EL1=0.42 eV.

The carrier mobility of the host material (Compound 4) alone of the light-emitting layer was measured in the same manner as in Example 1. The host material had an electron mobility of 7×10⁻⁴ cm²/Vs and a hole mobility of 2×10 cm²/Vs. It was found that the electron mobility of the host material was larger than the hole mobility of the host material. It was also found that the electron mobility of the host material was larger than 1×10⁻⁴ cm²/Vs.

Next, the electron mobility of the light-emitting layer (mixed film containing Compound 4 as a host material and doped with 8 wt % of Compound 3 as a luminescent dopant) was measured in the same manner as in Example 1. The light-emitting layer had an electron mobility of 2×10⁻⁷ cm²/Vs. It was found that the electron mobility of the light-emitting layer was lower than that of the host material alone by one or more orders of magnitude.

### COMPARATIVE EXAMPLE 1

A light-emitting device was produced in the same manner as in Example 1 except that a light-emitting layer was constituted of only a host material.

A voltage of 4.5 V was applied to the device while the ITO electrode (anode) was used as a positive electrode and the aluminum electrode (cathode) was used as a negative electrode. As a result, the device was observed to emit blue light derived from Compound 2 and having an emission luminance of 2,000 cd/m², an emission efficiency of 3.4 lm/W, and a maximum emission wavelength of 460 nm.

Further, a voltage was applied to the device under a nitrogen atmosphere with a current density kept at 30 mA/cm². As a result, a luminance half time was about 100 hours, which was shorter than that of Example 1.

### EXAMPLE 3

A light-emitting device was produced in the same manner as in Example 2 except that a material for an electron transport layer was changed to 2,9-bis[2-(9,9-dimethylfluorenyl)]phenanthroline.

A voltage of 4.5 V was applied to the device while the ITO electrode (anode) was used as a positive electrode and the aluminum electrode (cathode) was used as a negative electrode. As a result, the device was observed to emit blue light derived from Compound 3 and having an emission luminance of 2,400 cd/m², an emission efficiency of 5.1 lm/W, and a maximum emission wavelength of 462 nm.

Further, a voltage was applied to the device under a nitrogen atmosphere with a current density kept at 30 mA/cm². As a result, a luminance half time was as long as about 1,600 hours.

The measured energy gap of the electron transport material was 3.08 eV, which was larger than 3.00 eV.

### COMPARATIVE EXAMPLE 2

A light-emitting device was produced in the same manner as in Example 3 except that an electron transport material was changed to Alq represented by the following formula.

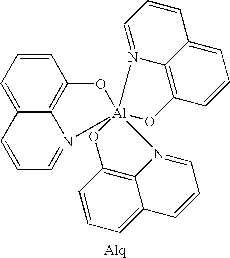

The device was driven by using the ITO electrode (anode) as a positive electrode and the aluminum electrode (cathode) as a negative electrode. The device was observed to emit bluish green light derived from Compound 3 and the electron transport material at an applied voltage of 4.5 V, but the device did not emit pure blue light.

The measured energy gap of the electron transport material (Alq) was 2.69 eV, which was smaller than 3.00 eV.

### COMPARATIVE EXAMPLE 3

A light-emitting device was produced in the same manner as in Example 3 except that a hole transport material was changed to DFLDPBi represented by the following formula.

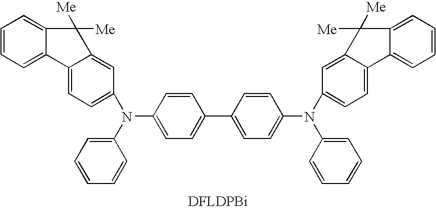

A voltage of 4.5 V was applied to the thus-obtained device by using the ITO electrode (anode) as a positive electrode and the aluminum electrode (cathode) as a negative electrode. As a result, the device was observed to emit blue light derived from Compound 3 and having an emission luminance of 660 cd/m² and a maximum emission wavelength of 460 nm. However, the emission efficiency of the device was 1.9 lm/W, which was lower than that of Example 3.

The measured energy gap of the hole transport material (DFLDPBi) was 2.97 eV, which was smaller than 3.15 eV.

### COMPARATIVE EXAMPLE 4

A light-emitting device was produced in the same manner as in Example 3 except that a hole transport material was changed to αNPD represented by the following formula.

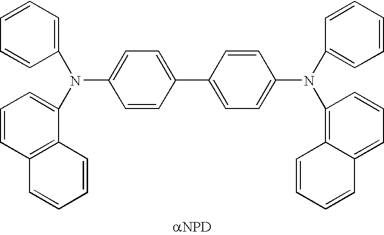

A voltage of 4.5 V was applied to the thus-obtained device by using the ITO electrode (anode) as a positive electrode and the aluminum electrode (cathode) as a negative electrode. As a result, the device was observed to emit blue light derived from Compound 3 and having an emission luminance of 570 cd/m² and a maximum emission wavelength of 463 nm. However, the emission efficiency of the device was 2.4 lm/W, which was lower than that of Example 3.

Further, a voltage was applied to the device under a nitrogen atmosphere with a current density kept at 30 mA/cm². As a result, a luminance half time was about 200 hours, which was shorter than that of Example 3.

The measured energy gap of the hole transport material (αNPD) was 3.10 eV, which was smaller than 3.15 eV.

### EXAMPLE 4

A chloroform solution to be applied to a glass substrate with ITO prepared in the same manner as in Example 1 was prepared by using DFLDPBi as a hole injection material in such a manner that the concentration of the material would be 0.13 wt %.

The solution was dropped onto the above-mentioned ITO electrode, and the whole was subjected to spin coating initially at a number of revolutions of 500 RPM for 10 seconds and then at a number of revolutions of 1,000 RPM for 1 minute, whereby a film was formed. After that, the resultant was dried for 10 minutes in a vacuum oven at 80° C., whereby the solvent in the thin film was completely removed. The formed hole transport layer had a thickness of 18 nm.

Next, Compound 5 shown below was deposited to form a hole transport layer having a thickness of 15 nm.

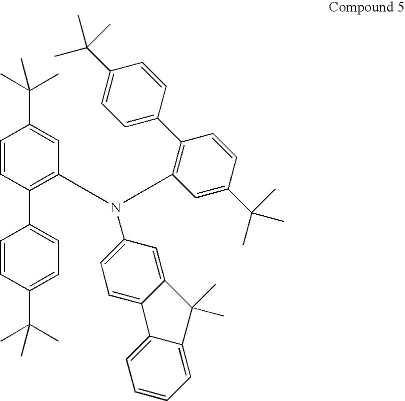

Next, a light-emitting layer was formed by simultaneously depositing Compound 6 shown below as a host material and Compound 3 as a luminescent dopant from different boats. The light-emitting layer had a concentration of Compound 3 of 5 wt % and a thickness of 30 nm.

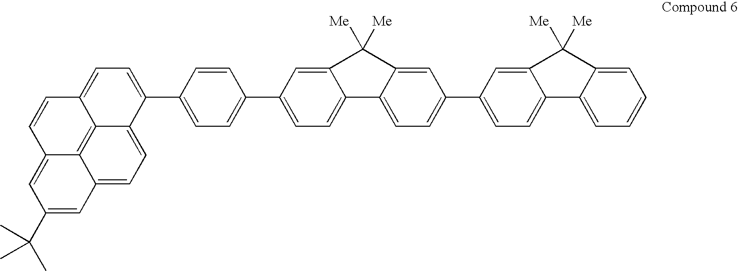

Further, steps subsequent to the formation of an electron transport layer were performed in the same manner as in Example 3.

A voltage of 4.5 V was applied to the device by using the ITO electrode (anode) as a positive electrode and the aluminum electrode (cathode) as a negative electrode. As a result, the device was observed to emit blue light having an emission luminance of 1,100 cd/m², an emission efficiency of 6.9 lm/W, and CIE xy chromaticity coordinates of (0.15, 0.19).

Further, a voltage was applied to the device under a nitrogen atmosphere with a current density kept at 30 mA/cm². As a result, a luminance half time was as long as about 1,200 hours.

The measured energy gap of the hole transport material (Compound 5) was 3.25 eV, which was larger than 3.15 eV.

In addition, the measured energy gap of the host material (Compound 6) of the light-emitting layer was found to be larger than that of the dopant material by 0.27 eV.

It was also found that the LUMO energy EL2 of the host material was −2.62 eV, the LUMO energy EL1 of the luminescent dopant was −3.06 eV, and EL2−EL1=0.44 eV.

### EXAMPLE 5

A light-emitting device was produced in the same manner as in Example 3 except that the dopant material of a light-emitting layer was changed to Compound 7 represented by the following formula and the mixed concentration of the dopant material was changed to 5%.

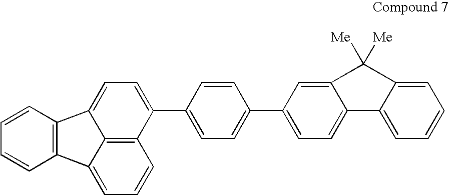

A voltage of 4.5 V was applied to the device by using the ITO electrode (anode) as a positive electrode and the aluminum electrode (cathode) as a negative electrode. As a result, the device was observed to emit blue light having an emission luminance of 2,100 cd/m², an emission efficiency of 4.5 lm/W, and CIE xy chromaticity coordinates of (0.15, 0.17).

Further, a voltage was applied to the device under a nitrogen atmosphere with a current density kept at 30 mA/cm². As a result, a luminance half time was as long as about 1,500 hours.

In addition, the measured energy gap of the dopant material (Compound 7) of the light-emitting layer was found to be smaller than that of the host material by 0.09 eV.

It was also found that the LUMO energy EL2 of the host material was −2.64 eV, the LUMO energy EL1 of the luminescent dopant was −3.17 eV, and EL2−EL1=0.53 eV.

### EXAMPLE 6

A light-emitting device was produced in the same manner as in Example 3 except that the dopant material of a light-emitting layer was changed to Compound 8 represented by the following formula and the mixed concentration of the dopant material was changed to 5%.

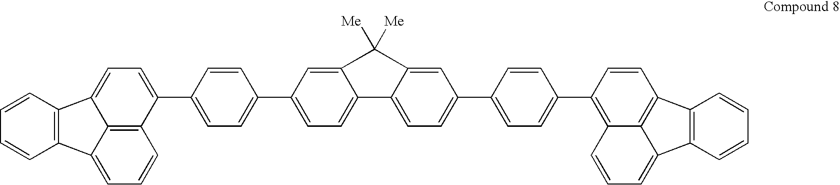

A voltage of 4.5 V was applied to the device by using the ITO electrode (anode) as a positive electrode and the aluminum electrode (cathode) as a negative electrode. As a result, the device was observed to emit blue light having an emission luminance of 2,300 cd/m², an emission efficiency of 5.0 lm/W, and CIE xy chromaticity coordinates of (0.15, 0.18).

Further, a voltage was applied to the device under a nitrogen atmosphere with a current density kept at 30 mA/cm². As a result, a luminance half time was as long as about 1,300 hours.

In addition, the measured energy gap of the dopant material (Compound 8) of the light-emitting layer was found to be smaller than that of the host material by 0.12 eV.

It was also found that the LUMO energy EL2 of the host material was −2.64 eV, the LUMO energy EL1 of the luminescent dopant was −3.15 eV, and EL2−EL1=0.51 eV.

### EXAMPLE 7

A light-emitting device was produced in the same manner as in Example 3 except that the host material of a light-emitting layer was changed to Compound 9 represented by the following formula, the concentration of a dopant material was changed to 12% and the thickness of the light-emitting layer was changed to 40 nm.

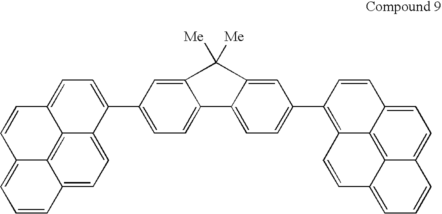

A voltage of 4.5 V was applied to the device by using the ITO electrode (anode) as a positive electrode and the aluminum electrode (cathode) as a negative electrode. As a result, the device was observed to emit blue light having an emission luminance of 4,500 cd/m², an emission efficiency of 6.8 lm/W, and CIE xy chromaticity coordinates of (0.15, 0.19).

Further, a voltage was applied to the device under a nitrogen atmosphere with a current density kept at 10 m A/cm². As a result, a luminance half time was as long as about 1,000 hours.

In addition, the measured energy gap of the host material (Compound 9) of the light-emitting layer was found to be larger than that of the dopant material by 0.15 eV.

It was also found that the LUMO energy EL2 of the host material was −2.78 eV, the LUMO energy EL1 of the luminescent dopant was −3.06 eV, and EL2−EL1=0.28 eV.

### COMPARATIVE EXAMPLE 5

A light-emitting device was produced in the same manner as in Example 3 except that the dopant material of a light-emitting layer was changed to Compound 10 represented by the following formula.

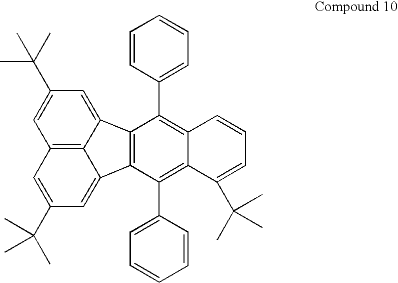

A voltage of 4.5 V was applied to the device by using the ITO electrode (anode) as a positive electrode and the aluminum electrode (cathode) as a negative electrode. As a result, the device was observed to emit blue light having an emission luminance of 4,800 cd/m², an emission efficiency of 5.6 lm/W, and CIE xy chromaticity coordinates of (0.15, 0.16).

Further, a voltage was applied to the device under a nitrogen atmosphere with a current density kept at 10 mA/cm². As a result, a luminance half time was about 150 hours, which was shorter than the lifetime of Example 7.

In addition, the measured energy gap of the dopant material (Compound 10) of the light-emitting layer was found to be smaller than that of the host material by 0.04 eV.

It was also found that the LUMO energy EL2 of the host material was −2.78 eV, the LUMO energy EL1 of the luminescent dopant was −2.91 eV, and EL2−EL1=0.13 eV, which was smaller than 0.15 eV.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority benefits of Japanese Patent application Nos. 2005-366556 filed Dec. 20, 2005, 2006-125013 filed Apr. 28, 2006 and 2006-278925 filed Oct. 12, 2006, the entire disclosure of which are incorporated by reference in their entirety.

1. An organic light-emitting device, comprising:
a pair of electrodes composed of an anode and a cathode; and
a layer composed of an organic compound and interposed between the pair of electrodes,
wherein the layer has a light-emitting region and contains a first compound including a fluoranthene skeleton and a second compound including a pyrene skeleton;
the second compound has an energy gap larger than an energy gap of the first compound; and
a lowest unoccupied molecular orbital energy EL1 of the first compound and a lowest unoccupied molecular orbital energy EL2 of the second compound satisfy a relationship of EL2−EL1≧0.15 eV.

2. An organic light-emitting device according to claim 1, wherein the second compound has the pyrene skeleton and a fluorene skeleton.

3. An organic light-emitting device according to claim 2, wherein the second compound is represented by the following general formula (1): 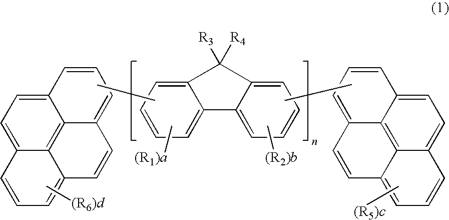
Wherein R₁ and R₂ groups each represent a hydrogen atom, a substituted or unsubstituted alkyl group, a substituted or unsubstituted aralkyl group, a substituted or unsubstituted aryl group, a substituted or unsubstituted heterocyclic group, a substituted amino group, a cyano group, or a halogen atom; R₁ groups bonded to different fluorenediyl groups may be the same or different, and R₂ groups bonded to different fluorenediyl groups may be the same or different; and R₁ groups bonded to the same fluorenediyl group may be the same or different, R₂ groups bonded to the same fluorenediyl group may be the same or different, and R₁ and R₂ groups bonded to the same fluorenediyl group may be the same as or different from each other;
R₃ and R₄ groups each represent a hydrogen atom, a substituted or unsubstituted alkyl group, a substituted or unsubstituted aralkyl group, a substituted or unsubstituted aryl group, or a substituted or unsubstituted heterocyclic group; R₃ groups bonded to different fluorenediyl groups may be the same or different, and R₄ groups bonded to different fluorenediyl groups may be the same or different, and R₃ and R₄ groups bonded to the same fluorenediyl group may be the same as or different from each other;
R₅ and R₆ groups each represent a hydrogen atom, a substituted or unsubstituted alkyl group, a substituted or unsubstituted aralkyl group, a substituted or unsubstituted aryl group, a substituted or unsubstituted heterocyclic group, a substituted amino group, a cyano group, or a halogen atom; R₅ groups may be the same or different, R₆ groups may be the same or different, and R₅ and R₆ groups may be the same as or different from each other; and
a and b each represent an integer of 1 to 3 and may be the same as or different from each other, c and d each represent an integer of 1 to 9 and may be the same as or different from each other, and n represents an integer of 1 to 10.

4. An organic light-emitting device according to claim 2, wherein the second compound is represented by the following general formula (2): 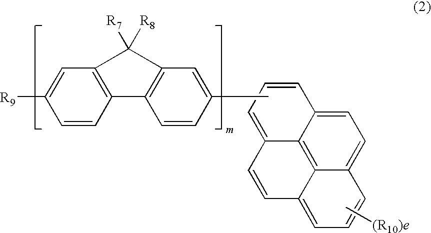
wherein R₇ and R₈ groups each represent a hydrogen atom, a substituted or unsubstituted alkyl group, a substituted or unsubstituted aralkyl group, a substituted or unsubstituted aryl group, or a substituted or unsubstituted heterocyclic group; and R₇ and R₈ groups may be the same or different;
R₉ group represents a hydrogen atom, a linear, branched, or cyclic alkyl group (one or more methylene groups of the alkyl group may be substituted by —O—, —S—, —CO—, —CO—O—, —O—CO—, —CH═CH—, —C≡C—, an arylene group that may have a substituent, or a heterocyclic group that may have a substituent; or a hydrogen atom of the alkyl group may be substituted by a fluorine atom), or a substituted or unsubstituted aryl group which has one or two rings (one or more CH groups of the aryl group may be substituted by an N atom);
R₁₀ group represents a hydrogen atom, a substituted or unsubstituted alkyl group, a substituted or unsubstituted aralkyl group, a substituted or unsubstituted aryl group, a substituted or unsubstituted heterocyclic group, a substituted amino group, or a halogen atom;
e represents an integer of 1 to 9, and when a plurality of R₁₀ groups are present, the plurality of R₁₀ groups may be the same or different; and
m represents an integer of 2 to 10, and the plurality of fluorenediyl groups may be the same or different.

5. An organic light-emitting device according to claim 2, wherein the second compound is represented by the following general formula (3): 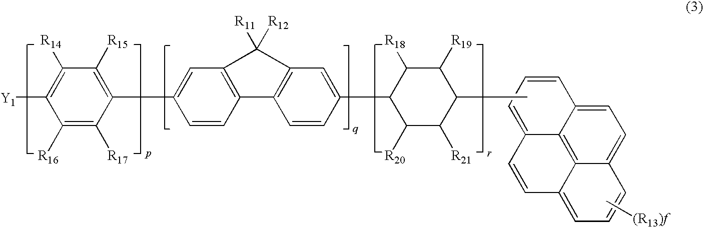
Wherein R₁₁, R₁₂, and R₁₄ to R₂₁ groups each represent a hydrogen atom, a substituted or unsubstituted alkyl group, a substituted or unsubstituted aralkyl group, a substituted or unsubstituted aryl group, or a substituted or unsubstituted heterocyclic group; and R₁₁ and R₁₂ groups may be the same or different;
Y₁ group represents a hydrogen atom or a substituted or unsubstituted fused ring structure composed of hydrocarbon;
q represents an integer of 1 to 10, and when q represents 2 or more, a plurality of fluorenediyl groups may be the same or different;
p means a number of a repeating structure of a substituted or unsubstituted phenyl group, and represents zero or an integer of 1 to 20, and;
r means a number of a repeating structure of a substituted or unsubstituted phenyl group, and represents an integer of 1 to 20; and
R₁₃ group represents a hydrogen atom, a substituted or unsubstituted alkyl group, a substituted or unsubstituted aralkyl group, a substituted or unsubstituted aryl group, a substituted or unsubstituted heterocyclic group, a substituted amino group, or a halogen atom, f represents an integer of 1 to 9, and when a plurality of R₁₃ groups are present, the plurality of R₁₃ groups may be the same or different.

6. An organic light-emitting device according to claim 1, wherein the first compound and the second compound are each constituted of only carbon and hydrogen.

7. An organic light-emitting device according to claim 1, wherein the first compound has the fluoranthene skeleton and a fluorene skeleton.

8. An organic light-emitting device according to claim 1, comprising the light-emitting layer including the light-emitting region, a hole transport layer in contact with an anode side of the light-emitting layer, and an electron transport layer in contact with a cathode side of the light-emitting layer,
wherein an energy gap of an electron transport material constituting the electron transport layer is larger than 3.00 eV, and an energy gap of a hole transport material constituting the hole transport layer is larger than 3.15 eV.

9. An organic blue-light-emitting device, comprising:
a pair of electrodes composed of an anode and a cathode; and
at least three layers interposed between the pair of electrodes, the at least three layers including a light-emitting layer, a hole transport layer in contact with the light-emitting layer, and an electron transport layer in contact with the light-emitting layer,
wherein the light-emitting layer contains at least a host material and a luminescent dopant material;
a lowest unoccupied molecular orbital energy ELH of the host material and a lowest unoccupied molecular orbital energy ELD of the luminescent dopant material satisfy a relationship of ELH−ELD≧0.15 eV;
a highest occupied molecular orbital energy EHH of the host material and a highest occupied molecular orbital energy EHD of the luminescent dopant material satisfy a relationship of EHH−EHD≧0 eV;
an electron mobility of the host material is larger than a hole mobility of the host material;
an energy gap of an electron transport material constituting the electron transport layer is larger than 3.00 eV; and
an energy gap of a hole transport material constituting the hole transport layer is larger than 3.15 eV.

10. An organic blue-light-emitting device according to claim 9, wherein an energy gap of the host material is larger than an energy gap of the luminescent dopant material.

11. An organic blue-light-emitting device according to claim 9, wherein the electron mobility μH of the host material is 1×10⁻⁴ cm²/Vs or more.

12. An organic blue-light-emitting device according to claim 9, wherein an electron mobility μE of the light-emitting layer and the electron mobility μH of the host material satisfy a relationship of μE/μH≦0.1.

13. An organic blue-light-emitting device according to claim 9, wherein the luminescent dopant material comprises a compound having a fluoranthene skeleton.

14. An organic blue-light-emitting device according to claim 9, wherein the host material comprises a compound having a pyrene skeleton.
